(19) United States
(12) Patent Application Publication
(10) Pub. No.: US 2024/0013154 A1
(43) Pub. Date: Jan. 11, 2024

(54) SYSTEM, METHOD AND COMPUTER PROGRAM PRODUCT TO DETERMINE COMPENSATION

(71) Applicant: ADP, Inc., Roseland, NJ (US)

(72) Inventors: Sriranjani CHIMAKURTHY, Hyderabad (IN); Arindam DAS, Hyderabad (IN); Francisco De Asis CASAS ALAMINOS, Parsippany, NJ (US); Waiwah PAK, Livingston, NJ (US)

(21) Appl. No.: 17/965,380

(22) Filed: Oct. 13, 2022

(30) Foreign Application Priority Data
Jul. 8, 2022 (IN) 202211039344

(51) Int. Cl. G06Q 10/105

(52) U.S. Cl. CPC G06Q 10/105

(57) ABSTRACT

The present disclosure relates generally to tools to determine compensation and, more particularly, to a system, method and computer program product to determine workforce compensation.

### TECHNICAL FIELD

The present disclosure relates generally to tools to determine compensation and, more particularly, to a system, method and computer program product to determine workforce compensation.

### BACKGROUND

The ability to analyze compensation quickly and easily across an entire organization is difficult to achieve. Without the ability to compare compensation to peers and competitors, organizations cannot make informed pay decisions. For example, the organization may be paying employees in less critical roles above the market-rate or paying top performers below the market-rate. The latter issue may increase attrition and decrease productivity and revenue. Also, compensation strategies that are not aligned to peers or geography make it difficult to attract top talent.

### SUMMARY

In a first aspect of the present disclosure, a method of comparing compensation, comprises: obtaining, by a computer system, a compensation benchmark for a particular job; obtaining, by the computer system, information of employees for the particular job title; and generating, by the computer system, a comparison of compensation of the employees for the particular job title and the compensation benchmark.

In another aspect of the present disclosure, there is a computer program product for providing competitive compensation to employees of an organization. The computer program product includes one or more computer readable storage media having program instructions collectively stored on the one or more computer readable storage media. The program instructions are executable to: obtain selected target market settings; obtain benchmark compensation associated with the selected target market settings; and determine competitiveness of an organization's compensation based on the selected target settings and the benchmark compensation; and provide a report with recommendations to ensure the competitiveness of the organization's compensation.

In a further aspect of the present disclosure, there is a computer system. The system includes a processor, a computer readable memory, one or more computer readable storage media, and program instructions collectively stored on the one or more computer readable storage media. The program instructions are executable to determine market compensation of an employee by comparing current compensation of an employee based on market settings associated with a predetermined job title or job description with a benchmark compensation for the predetermined job title or job description.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative architecture of a computing system implemented in embodiments of the present disclosure.

FIG. 2 shows an exemplary cloud computing environment in accordance with aspects of the present disclosure.

FIGS. 3-34 show various user interfaces, drop down menus and/or graphical representations with underlying functionality in accordance with aspects of the present disclosure.

FIG. 35 depicts a block diagram of components and respective functionality in accordance with aspects of the present disclosure.

FIG. 36 depicts an exemplary flow for a process in accordance with aspects of the present disclosure.

### DETAILED DESCRIPTION OF ASPECTS OF THE INVENTION

The present disclosure relates generally to tools to determine comparisons of compensation and, more particularly, to a system, method and computer program product (hereinafter also referred collectively as “tools”) to compare compensation across different organizations. In accordance with aspects of the present disclosure, the tools provided herein are capable of assessing the competitiveness of compensation across an entire organization using benchmarking capabilities. For example, the tools are configured to and capable of allowing clients to identify jobs and employees above or below market pay, identify outliers within the organization, and build retention and compensation strategies based on the insights gleaned from the compensation comparisons. Advantageously, by implementing the tools described herein, it is now possible to, amongst other features: (i) analyze compensation quickly and easily across the entire organization; (ii) compare compensation to peers and competitors, and within organizations to make informed pay decisions; (iii) adjust pay scales for those in less critical roles as well as top performers that are below market-rate; (iv) decrease attrition and increase productivity and revenue; and (v) devise compensation strategies that are aligned to peers or geography to attract top talent.

In more specific embodiments, the tools provided herein provide a technical solution to a technical problem of comparing compensation, and properly devising and implementing pay scales and strategies that meet industry standards for geography, tenure of employee, job title/description and other factors. The tools provided herein may aggregate data from disparate systems regarding a plurality of factors associated with employment information and geographic region, perform analysis on the data using machine learning and/or neural network computing to construct comparisons of worker compensation based on different criteria, and provide reports, notifications and recommendations based on worker compensation comparisons, which can be used to provide notifications to the organization, e.g., managers, human resources personnel, etc., to generate or provide remedial solutions.

For example, the tools provided herein are configured to and are capable of providing the following functionality on a computing infrastructure, system, or computer program product (e.g., software product):
(i) Evaluate pay competitiveness of jobs across an entire organization and see how that organization's overall compensation compares to the market or internally within the organization;
(ii) Perform compensation analysis at the organization, department, job, employee level, and pay grade;
(iii) Identify jobs and employees where compensation is not aligned with the market and take action to ensure the organization is neither over nor underpaying workers;
(iv) Analyze multiple dimensions affecting compensation;
(v) Align employee pay with the organization's overall compensation strategy and the market;
(vi) Reduce turnover cost and the expense of hiring and training new employees by reducing attrition and increasing employee retention;
(vii) Improve the organization's ability to attract top talent when new roles are created, or existing roles become vacant;
(viii) Identify pay grades which require adjustment to the pay ranges in comparison with market; and
(ix) Estimate the cost that is needed to be budgeted to bring employees to market pay.

Implementations of the present disclosure may be a computer system, a computer-implemented method, and/or a computer program product. The computer program product is not a transitory signal per se, and may include a computer readable storage medium (or media) having computer readable program instructions thereon for causing a processor to carry out aspects of the present disclosure. As described herein, the computer readable storage medium (or media) is a tangible storage medium (or media). It should also be understood by those of skill in the art that the terms media and medium are used interchangeable for both a plural and singular instance.

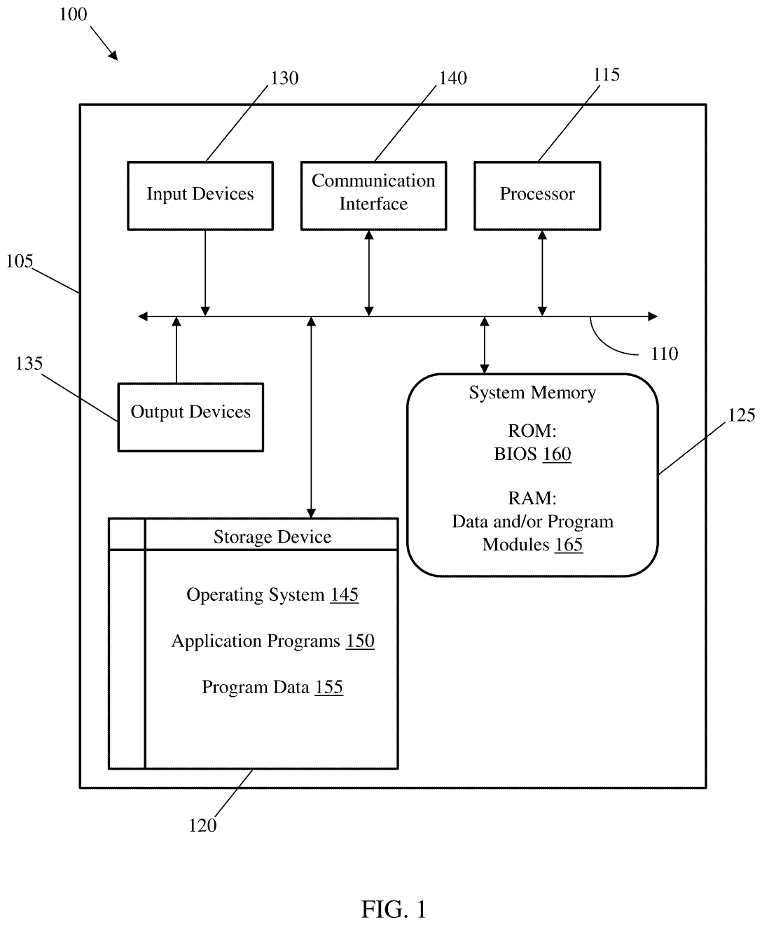

FIG. 1 is an illustrative architecture of a computing system 100 implemented in embodiments of the present disclosure. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100.

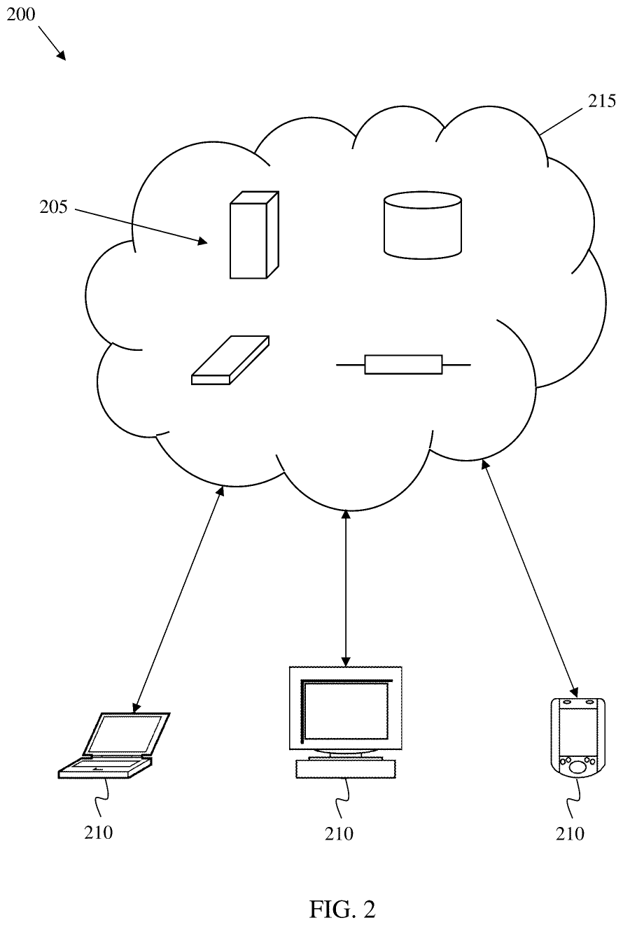

As shown in FIG. 1, computing system 100 includes a computing device 105. The computing device 105 can be resident on a network infrastructure such as within a cloud environment as shown in FIG. 2, or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present disclosure, which may be operatively implemented by the computer readable program instructions.

For example, processor 115 enables the computing device 105 to assess an organization's compensation strategy compared to other similar organizations within a client base by using different criteria including, e.g., geography, job title, job description, tenure of employee, industry, etc. The comparisons may be based on benchmarks formulated from information from similar organizations. These benchmarks may be based on job type, tenure, dates, geographic locations, employees, etc. This serves as the organization's benchmark, which can be changed or refined. In this way, organizations can summarize their overall compensation by role and/or by employee or other metric, and view market gaps between their compensation and the marketplace (e.g., based on geography, tenure, etc.).

The processor 115 also provides quantitative measures to illustrate investment needed to bring an organization's compensation to a target percentile in their market. The compensation insight function details the parameters, for example, average tenure and turnover rate for their peers, to further assess how competitive their pay is compared to a particular market.

The processor 115 further provides benchmarking capabilities at the international, national, state and other micro geographic levels. As an example, the national level may be calculated using data from the whole country while the state level analysis uses data from each state, leading to significant differences in the benchmark calculations depending on the state(s) where employees are located. Users can further tailor their benchmarks with settings based on additional filters such as revenue size, number of employees, and industry, etc. As part of the set-up, clients can match the jobs at their organization to a job's taxonomy including those provided by government through, for example, the Bureau of Labor Statistics or a service provider (e.g., ADP Inc.). Once set up is complete, users will have easy access to the data they need to verify where they are lagging or leading in compensation compared to their competitors.

In embodiments, processor 115 may receive input signals from one or more input devices 130 and/or drive output signals through one or more output devices 135. The input devices 130 may be, for example, a keyboard, touch sensitive user interface (UI), etc., as is known to those of skill in the art such that no further description is required for a complete understanding of the present disclosure. The output devices 135 can be, for example, any display device, printer, etc., as is known to those of skill in the art such that no further description is required for a complete understanding of the present disclosure.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to provide compensation comparisons. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

FIG. 2 shows an exemplary cloud computing environment 200 in accordance with aspects of the disclosure. Cloud computing is a computing model that enables convenient, on-demand network access to a shared pool of configurable computing resources, e.g., networks, servers, processing, storage, applications, and services, which can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may include one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software and/or hardware that performs one or more of the aspects, functions and/or processes described herein may be accessed and/or utilized by a client (e.g., an enterprise or an end user) as one or more of a SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

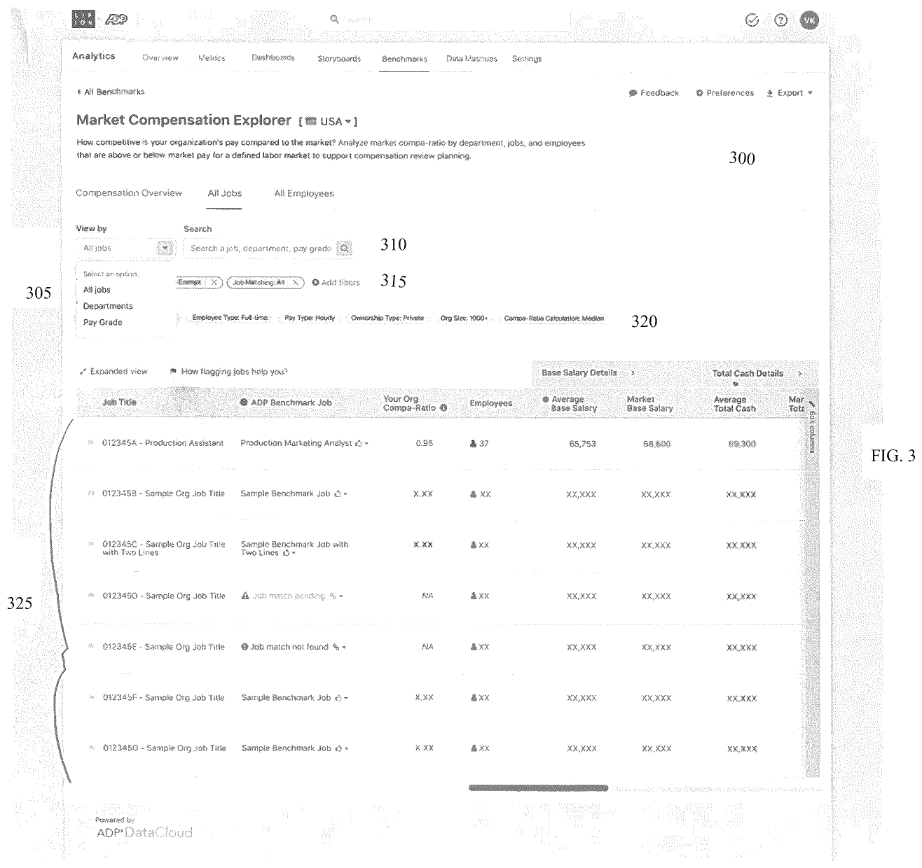

FIGS. 3-19 show various user interfaces and underlying functionality in accordance with aspects of the present disclosure. The user interfaces and their underlying functionality can be provided using one or more program modules such as program modules 165 described with respect to FIG. 1. In embodiments, separate modules may be integrated into a single module. Additionally, or alternatively, a single module may be implemented as multiple modules. In practice, the environment may include additional devices and/or networks; fewer devices and/or networks; different devices and/or networks; or differently arranged devices and/or networks than illustrated in FIG. 1.

In embodiments, the various user interfaces shown in FIGS. 3-19 leverage robust compensation benchmarks to perform compensation competitiveness assessment across an entire organization. As shown in the figures and as described in more detail herein, the various user interfaces and their underlying functionality provide proactive insights to: (i) evaluate the pay competitiveness of every job in an organization in relation to the market; (ii) easily identify jobs and employees with compensations off a target market and take action to bring these to target; (iii) analyze multiple dimensions affecting compensation such as tenure, geography, job title, etc.; (iv) align employee pay with compensation strategy and market; (v) enhance employee retention, thereby reducing hiring expenses and harmful knowledge drain; and (vi) better appeal to new hires, improving the ability to attract top talent.

As shown in FIG. 3, for example, a user interface 300 includes a compensation overview of all jobs. The view may also be based on an overview of all employees or compensation, as examples. The user interface 300 includes drop down menu 305, which includes a selection for all jobs, departments or pay grade, as examples. A search field 310 may also be provided to configure specific searches for, e.g., job department, pay grade and other factors. The user interface 300 also includes a filter 315. In embodiments, the filter 315 may include, e.g., non-exempt employees, job matching for all, highest salary increase based on percentage and high tenure, as shown in FIG. 7 for example. The user interface 300 may also include benchmark preferences 320. The benchmark preferences 320 may include industry type, employee type, pay type, ownership type, organizational size and comparison ratio (Compa-Ratio) calculation based on a median salary, amongst other features.

In embodiments, the Compa-ratio is a measure that expresses current pay rates as a percentage of range midpoints. For example, where the midpoint of a pay range represents full market pay, the ratio of the employee's actual salary to that midpoint indicates whether the employee is paid below, at or above market rates.

As further shown in FIGS. 3-9, the user interface 300 may include an expanded view 325. The expanded view 325 may include different columns tailored to the user. For example, the expanded view 325 may include job title, benchmark job organization, comparison ratio, number of employees, average base salary, or market based salary as shown in FIG. 3, in addition to turn over rate, time to fill, FLSA status, and average tenure as shown in FIG. 5 (amongst other factors that may be of interest to the user). As further shown in FIG. 3, for example, job title may be any job title that has been selected, e.g., production assistant. The benchmark job may be associated with the production assistant, such as e.g., production market analyst. In embodiments, selecting the proper job title and/or description ensures accurate analysis. For example, if the jobs are not matched, the tool will not have a benchmark value for those jobs and all the employees with such title may not be accounted in the analysis.

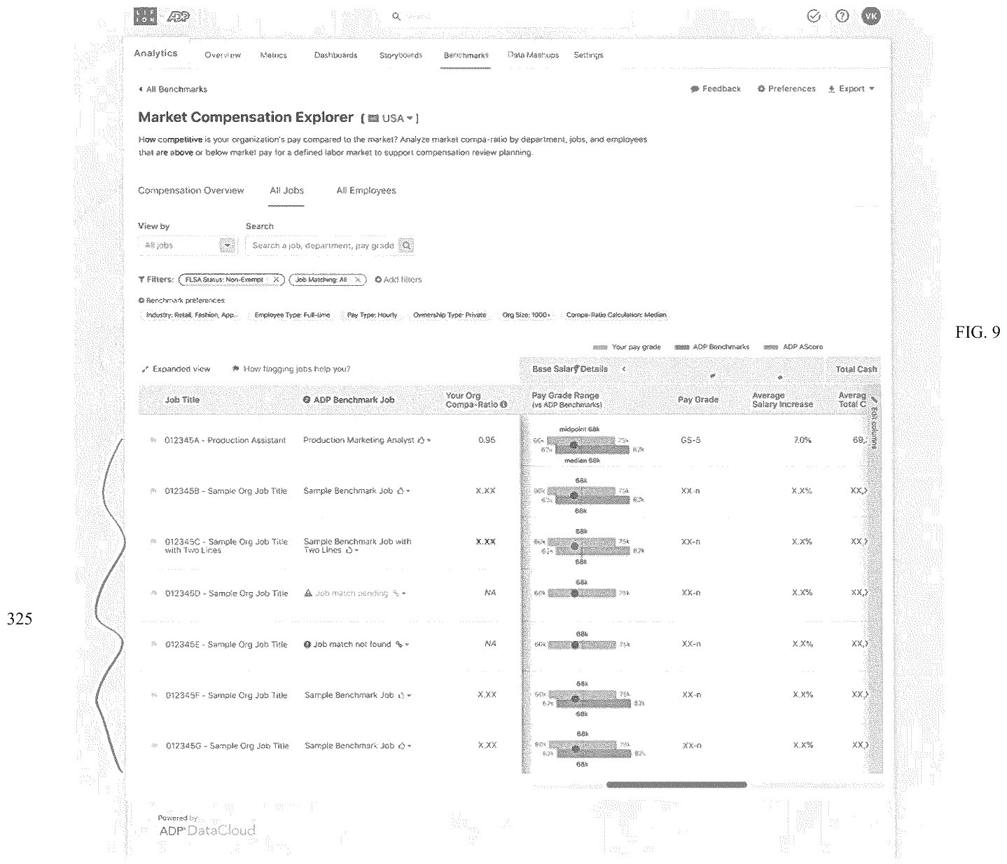

As shown in FIG. 9, for example, the expanded view 325 may further include pay grade range, pay grade, average salary increase, and average total cost. The pay grade range may be compared to a particular benchmark and may be shown in a graphical format. This benchmark may be based on geography, industry, tenure of employee or, median, average, or another percentile basis.

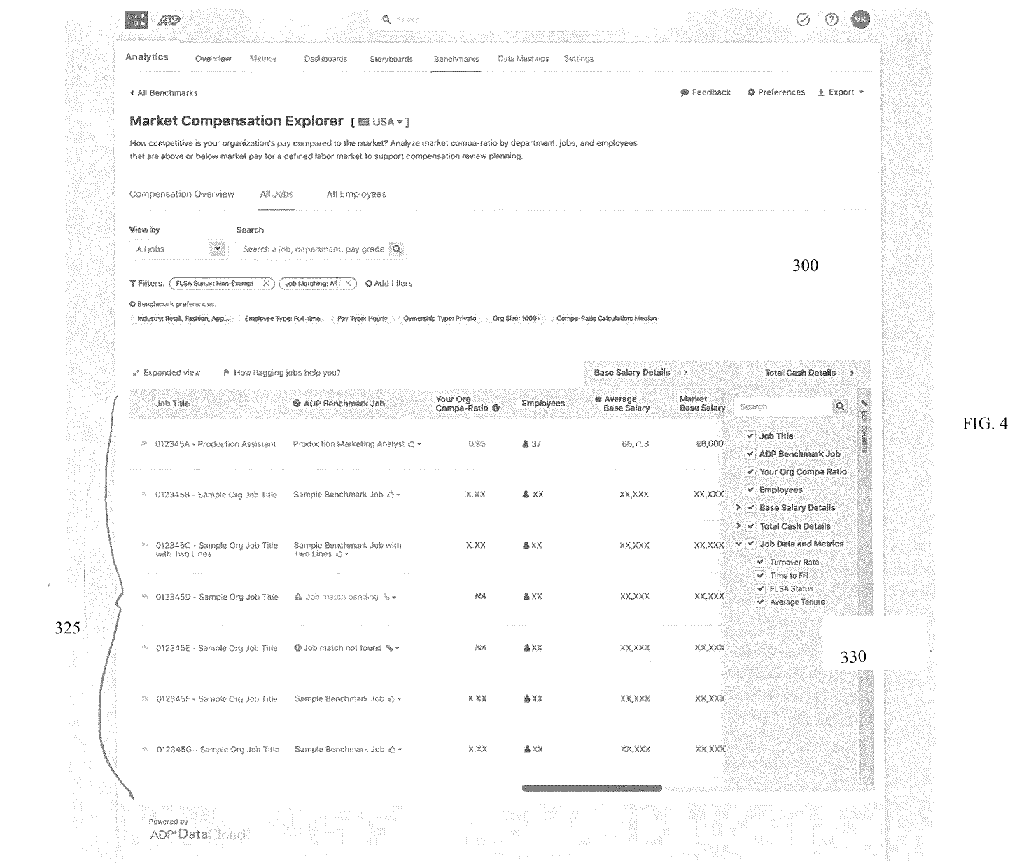

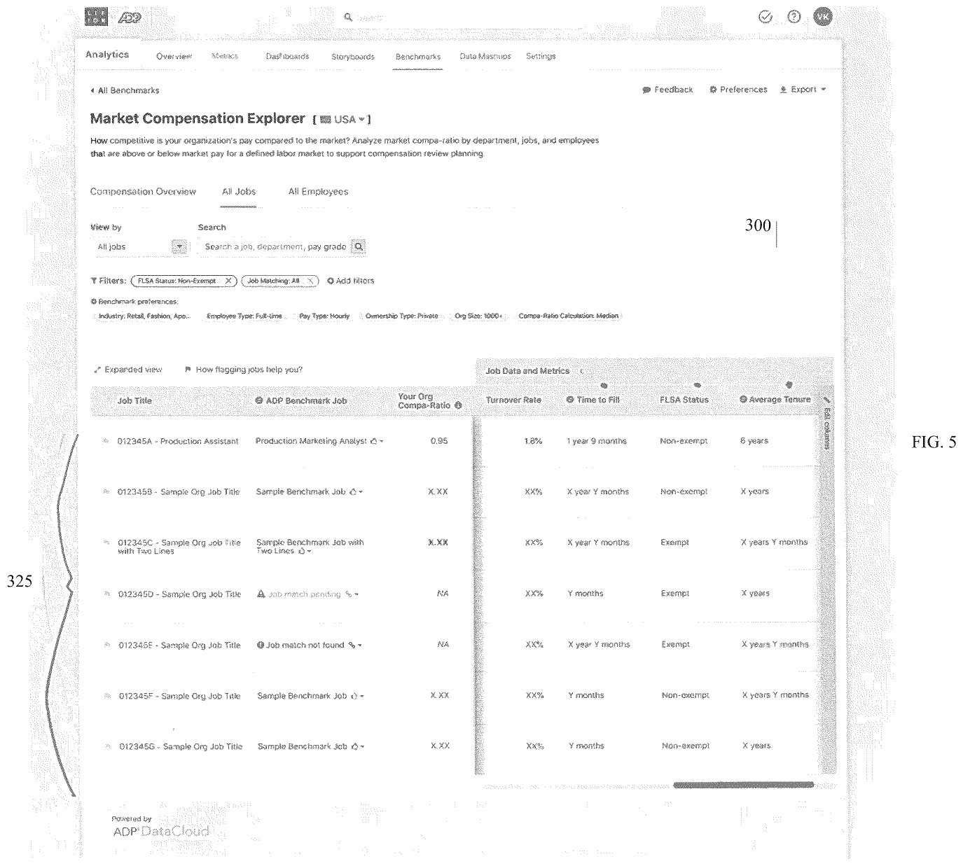

Referring to FIG. 4, a user can conduct an analysis based on other search criteria using search field 330. The search may be based on different information which can be obtained from many different disparate databases. In fact, any information obtained, analyzed and compared in these interfaces may be obtained from disparate databases that conventionally do not share such information. These databases may be, for example, human resources databases, payroll databases, benefits system databases, talent and acquisition systems, amongst others. These databases may be provided by a single service provider (e.g., ADP Inc.) or multiple service providers.

In any of the user interfaces shown herein, the search may be based on, e.g., job title, benchmark job, organization, comparison ratio, employees, base salary details, total cash details, job data and metrics, etc. For example, the job data and metrics may be based on turnover rate, time to fill position, FLSA status, and average tenure for an employee. Each of these particular filters may be used in order to gather different information for a comparison of job title, employees, compensation, overview, etc. These different criteria may then be displayed in the expanded view 325 in a column format for example.

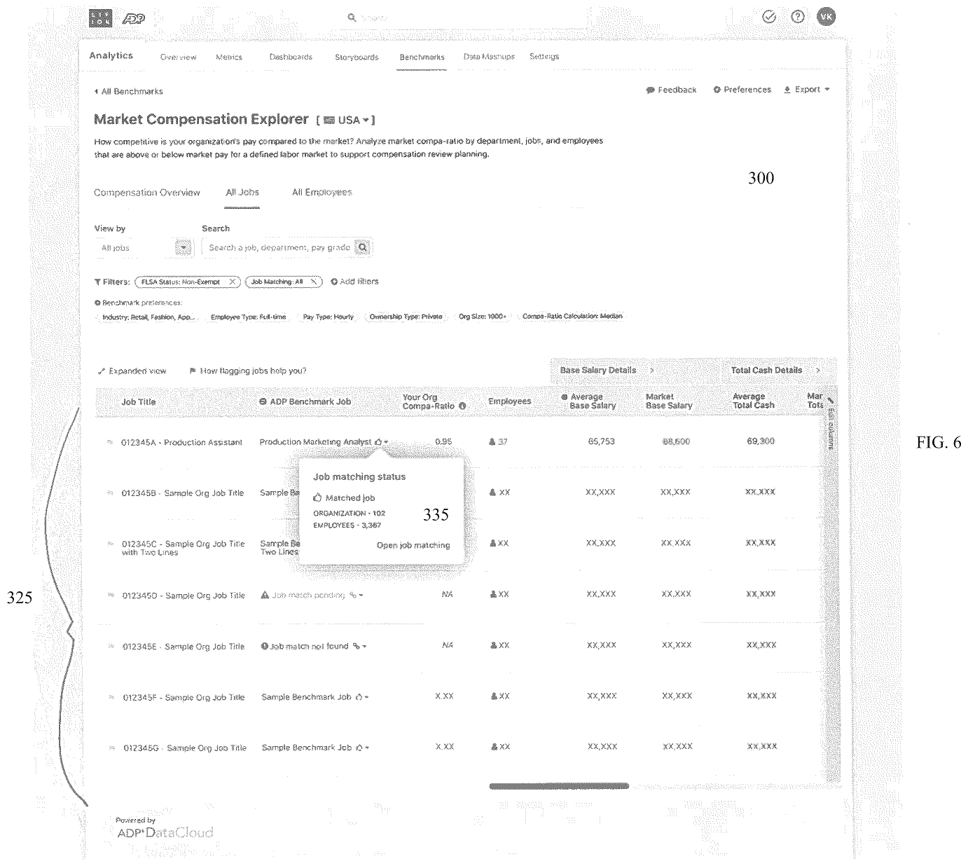

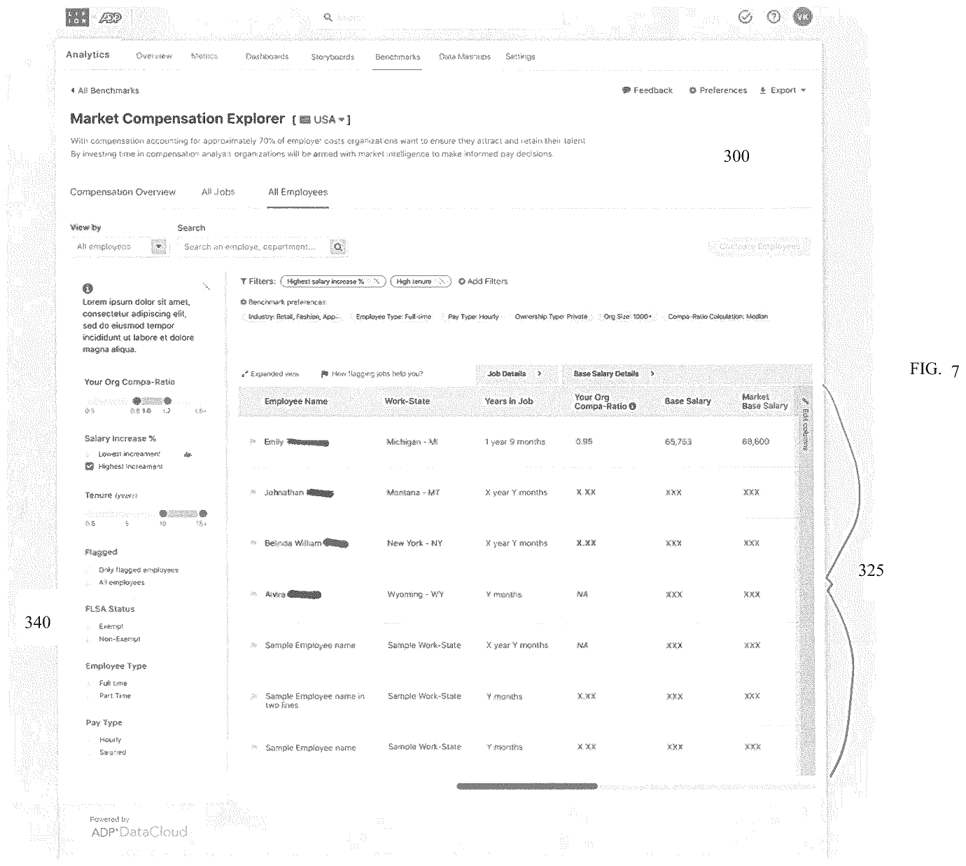

The expanded view 325 may include other granular information using, for example, a box 335 as shown in FIG. 6. For example, by selecting production market analysis, it is possible to determine a matched job status based on, for example, organization and number of employees.

Similarly, as shown in FIG. 7, it is also possible to filter additional information on a more granular level by using filter 340. The filter 340 may include information such as, e.g., salary increase %, tenure, flagged employees or all employees, FLSA status, employee type and pay type. These criteria can be selected individually or in any combination to populate the expanded view 325 shown in FIG. 7.

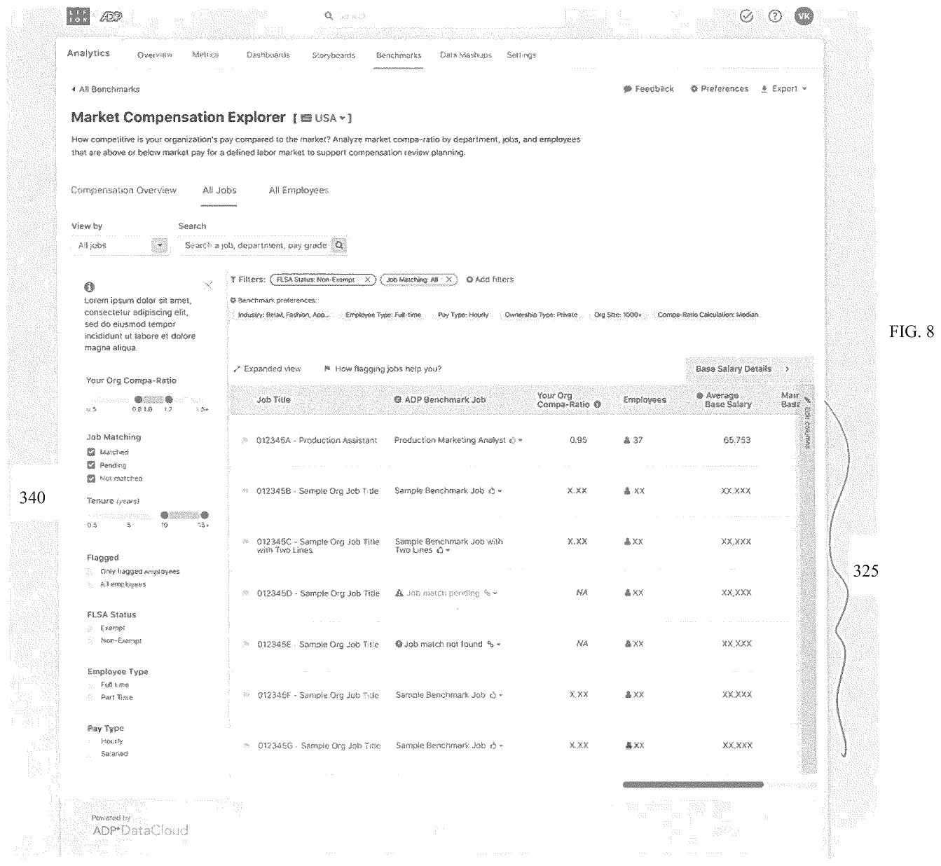

FIG. 8 shows an additional filter 350. This additional filter 350 allows the user to select job matching, as well as organizational comparison ratio. The organizational comparison ratio may include a graphical slide rule to determine different ratios of interest. Similarly, the tenure may include a graphical slide rule to determine different tenures of interest. As with any of the different filtered factors, the average tenure or turnover rate (amongst others) may be used to further assess a job's compensation competitiveness.

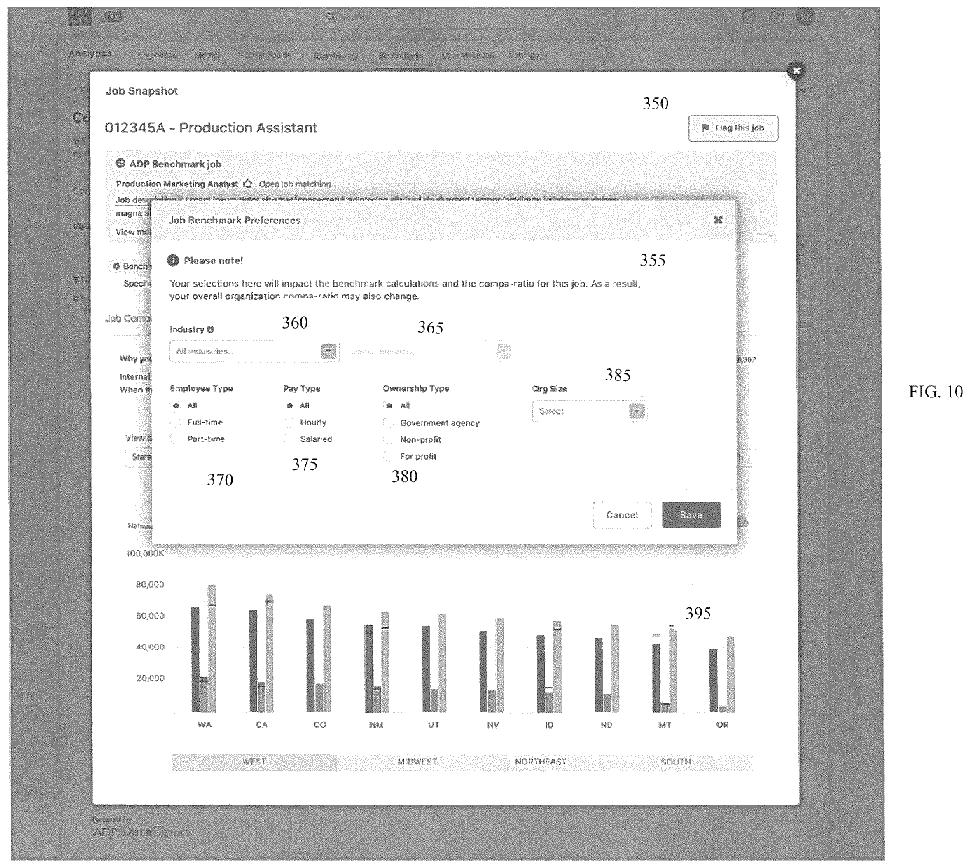

FIGS. 10-12 show a user interface 350 based on a granular view of job type. This user interface 350 may also be based on other criteria including job description, tenure or other criteria described herein. Beyond market gap and compensation insights, the average tenure or turnover rate (among other metrics) may further assist in assessing an organization's competitiveness regarding the compensation for these jobs.

In the user interface 350, the user selected production assistant. The user may select certain benchmark preferences as shown in menu 355. The benchmark preferences may be used for comparisons of the user's organization, based on the same criteria. For example, a benchmark of salary based on a geographic location would be used to compare a salary of an organization in the same geographical location. As with use of any of the benchmarks, should the salary of the employee of the organization within the same geographical location be lower than the benchmark, it may be indicative that the employee is underpaid, possibly leading the employee to seek a new job with a more competitive compensation.

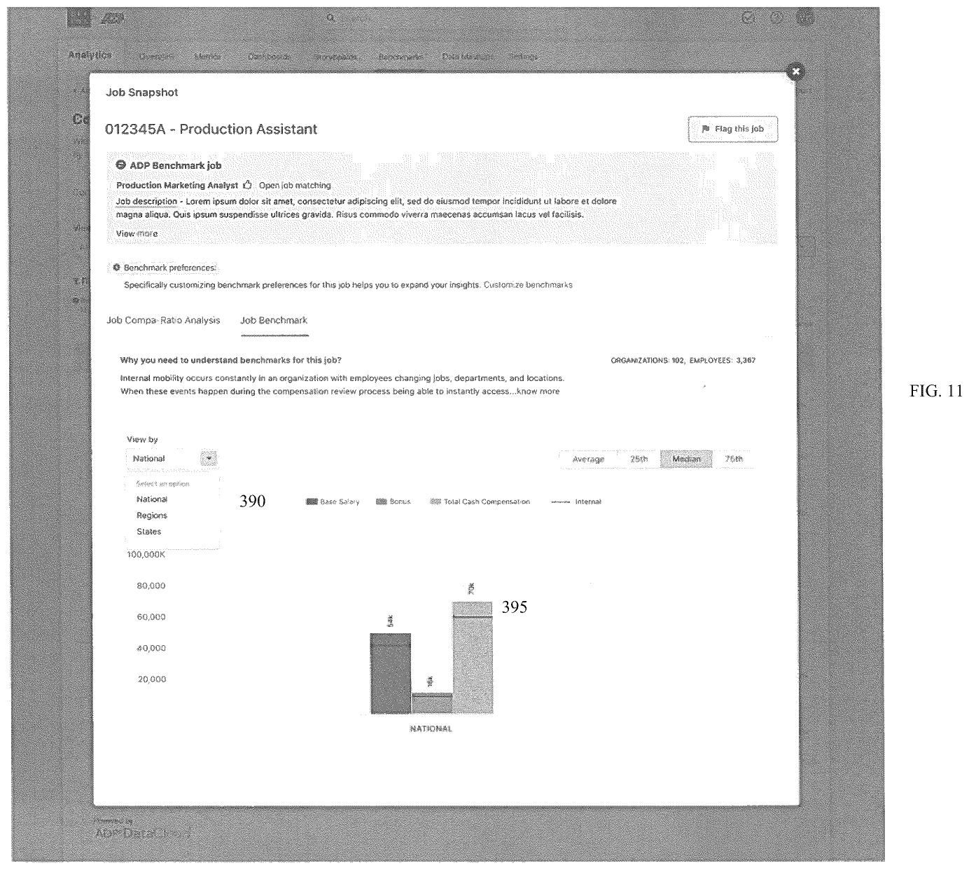

The preferences may include industry 360 or other search criteria 365 based on a particular geographic location, e.g., national, regional state, etc. (as shown in FIG. 11). The menu 350 shown in FIG. 10 may include different search criteria used for comparison purposes, e.g., employer type 370, pay type 375, ownership type 380 and dropdown menu 385 for organization size, amongst other features.

Once these criteria are selected, the user interface 350 will automatically show comparisons based on a particularly selected geographic region, e.g., region, state or national, etc. to the benchmarks, for example and to other employees with the same job title or other filtered criteria selected by the user. The comparison can be provided in a graphical format (e.g., bar graph) in order to compare base salary, bonuses and total cash compensation as an example.

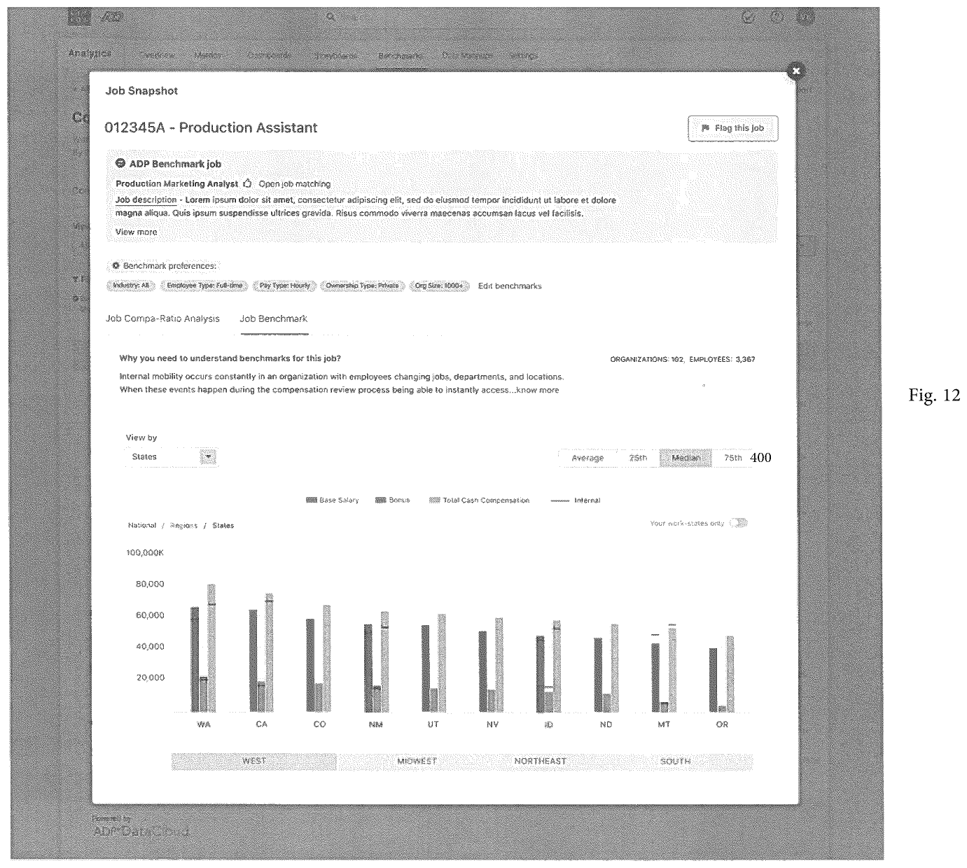

As further shown in FIG. 12, the base salary, bonus and total cash compensation may be based on different percentiles, including average 25th percentile, 75th percentile, etc., as shown in box 400. The line 395 in FIGS. 10-12 represents the selected criteria, e.g., median of these comparisons.

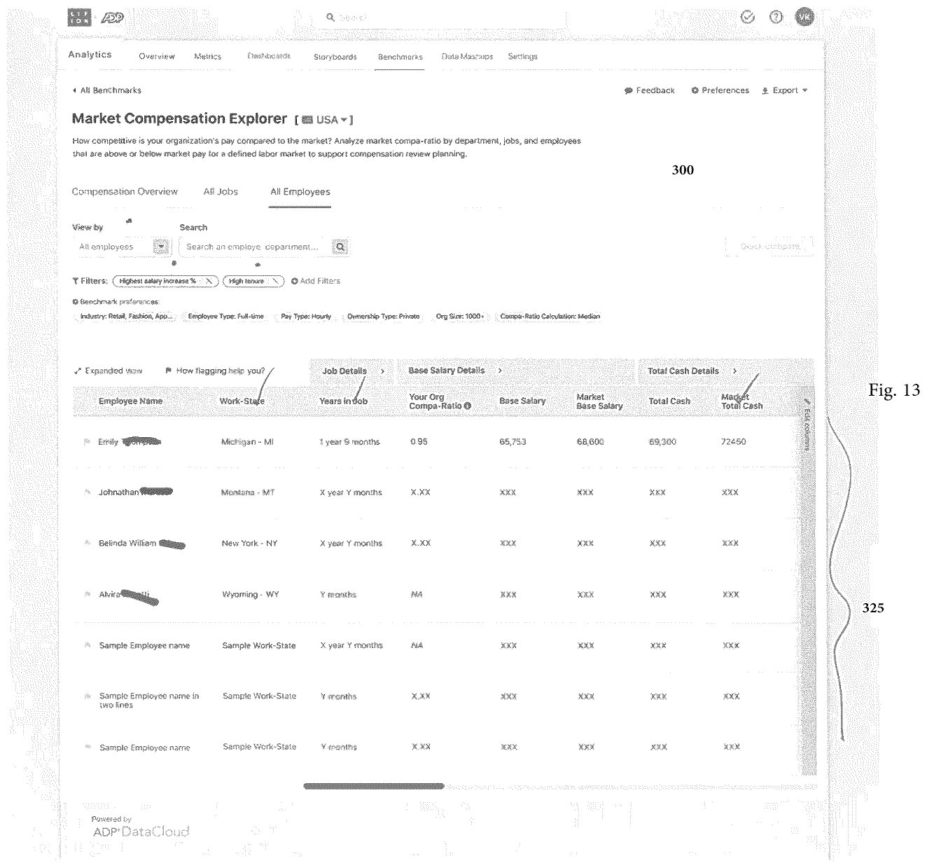

FIG. 13 shows the user interface 300 with additional expanded columns in the expanded view 325. These additional expanded columns include work state, years in job and market total cash, for comparison purposes. It should be understood, though, that other criteria or expanded views may be shown depending on the particular criteria selected by the user.

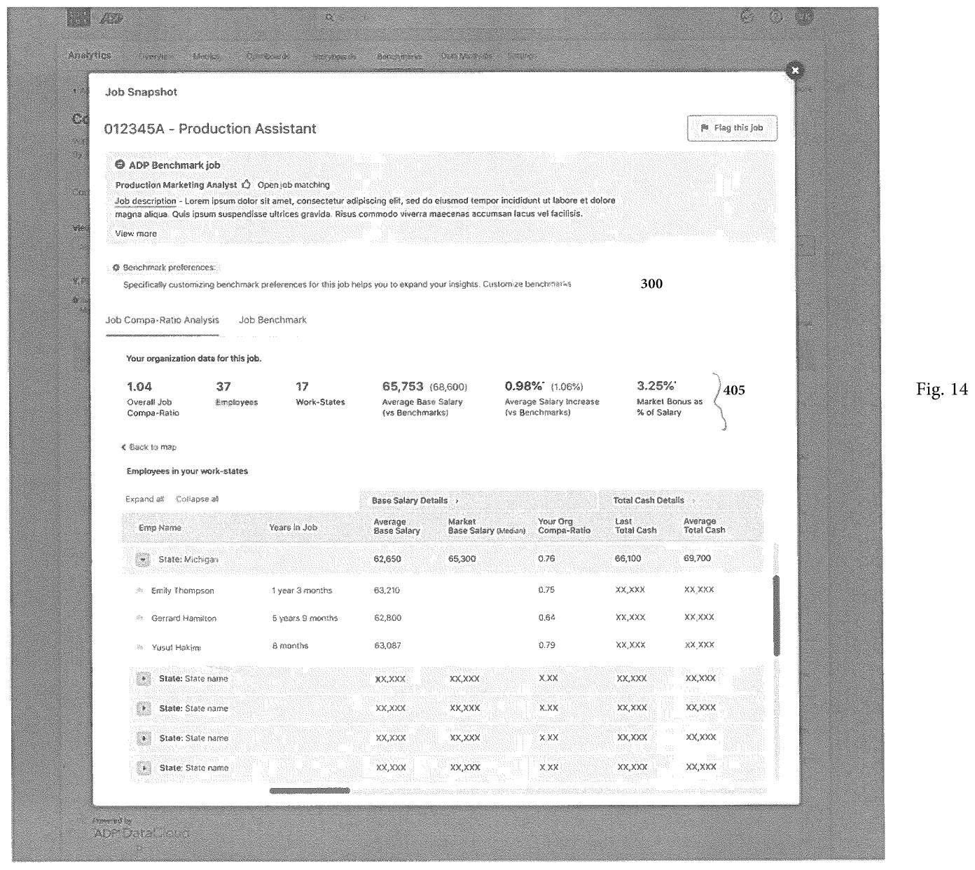

FIG. 14 shows the user interface 300 with additional summary information for organizational data as shown at reference numeral 405. This additional data may include, e.g., overall job compensation ratio, number of employees, work state, average base salary versus benchmark, average salary increase versus benchmark, and market bonus as percent of salary. This summary 405 may also include other selected criteria based on a customization of the benchmark performance in addition to job descriptions or other factors as selected by the user.

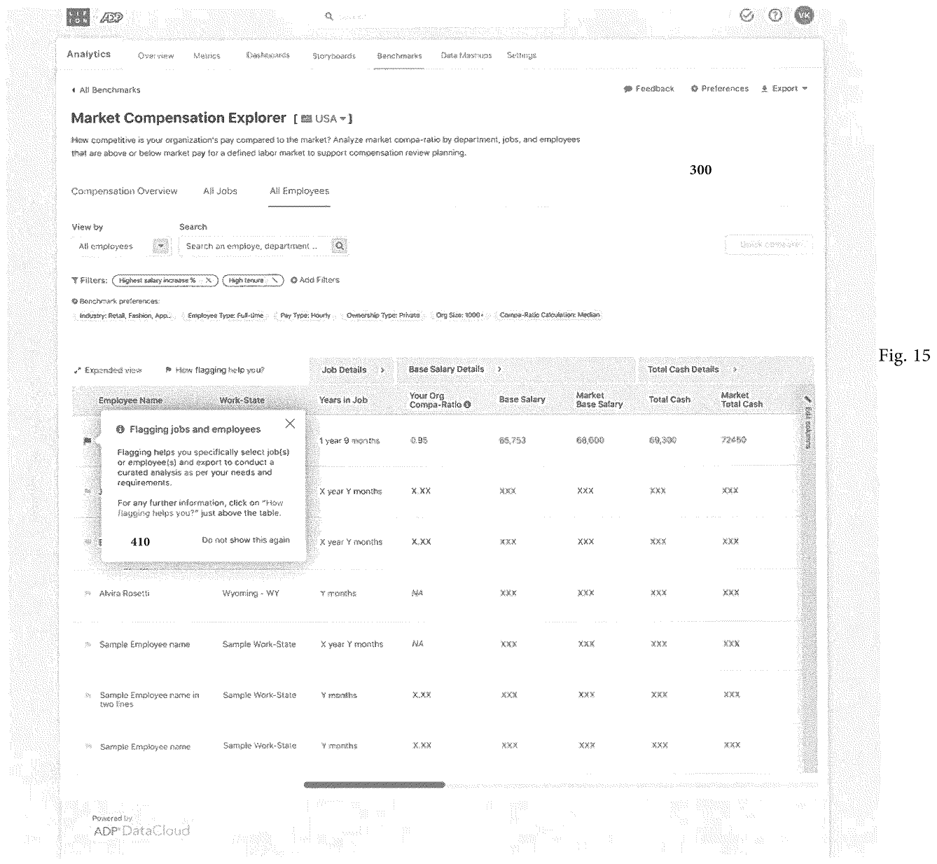

FIG. 15 shows user interface 300 with a pop-up box 410 associated with flagging a particular job and/or employee. The flagging helps the user to specifically select job(s) or employee(s) and to export this information to conduct a curated analysis as per the user's needs and/or requirements.

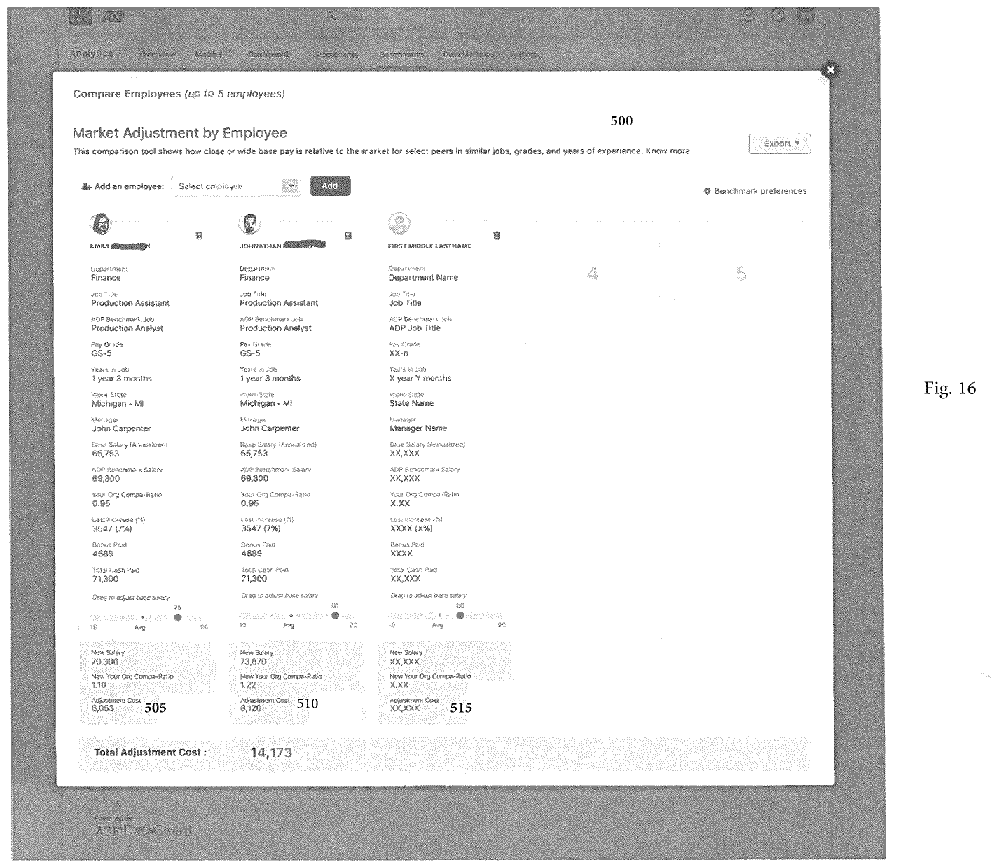

FIG. 16 shows a side-by-side analysis of different employees in user interface 500. In this interface 500, any number of employees or other criteria, e.g., job type, geographic location, etc., may be compared. The comparison may be a side-by-side comparison based on information such as job title, benchmark job pay grade, years in the job, work state manager, base salary, benchmark salary, comparison ratio, last increased percentage, paid bonus and total cash paid. Boxes 510-515 may show calculated information using the above criteria or other criteria described herein. The calculated information may include new salary, new organizational comparison ratio and adjustment costs, as examples. This information may be used by the organization to assess employee pay and, possibly, costs of retention.

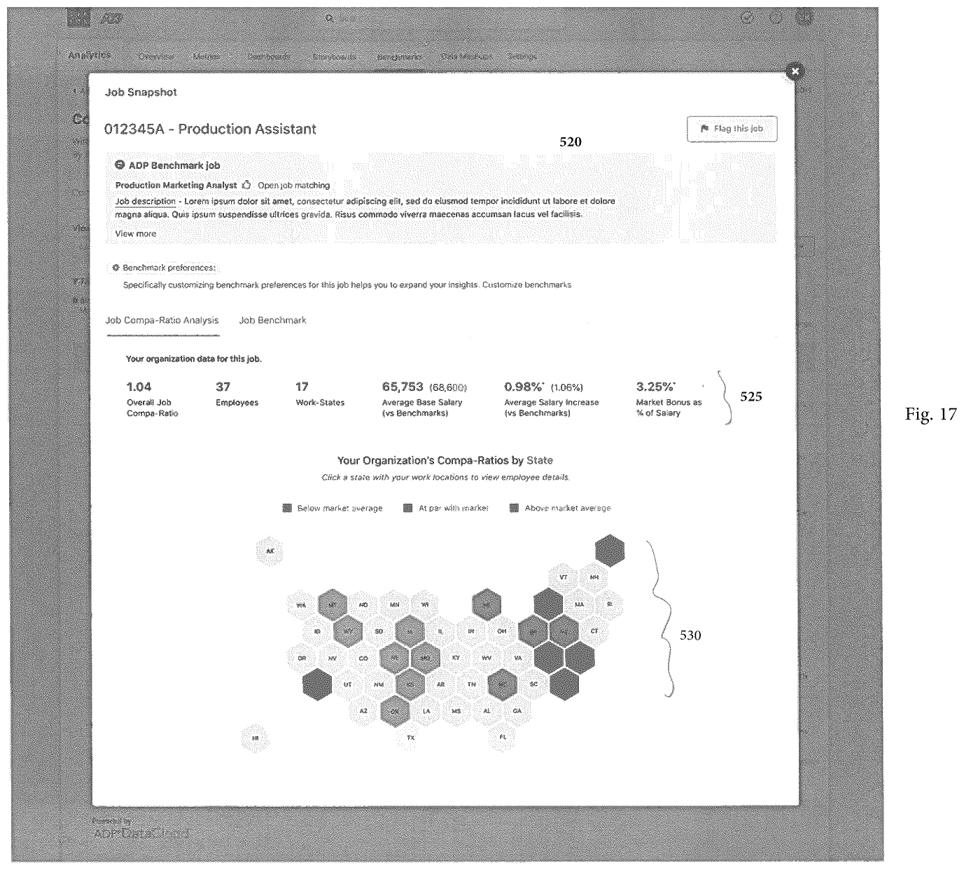

FIG. 17 shows an additional user interface 520 based on a job comparison ratio analysis for a particular job title (although other criteria may be used). This interface 520 includes organizational data at reference numeral 525, in addition to a graphical representation of comparison ratios at reference numeral 530. The organizational data 525 may include, e.g., overall job comparison ratio, number of employees, work states, average base salary versus benchmarks, average salary versus benchmarks, and market bonus as a percentage of salary, as examples. The graphical representation 530 may be a graphical representation which allows a user to select any particular state (or other geographical location). By selecting the geographical location, relevant information for the geographical location may be automatically displayed.

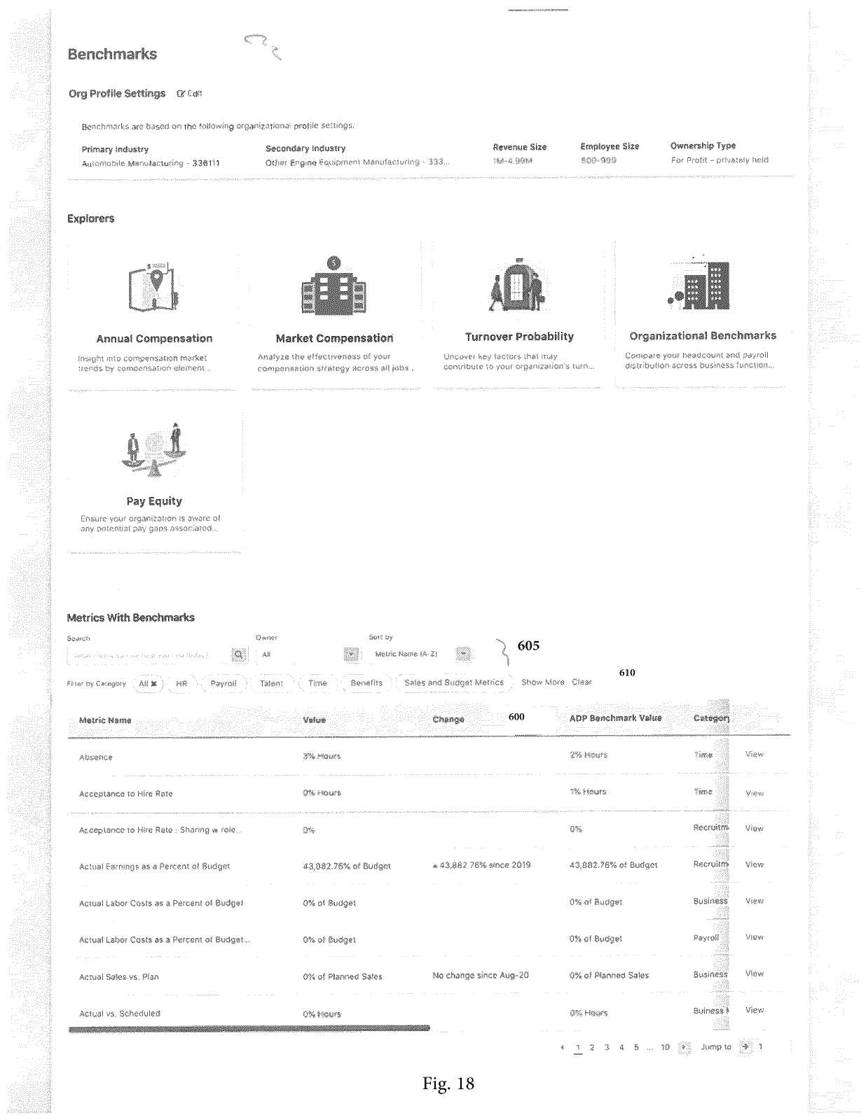

FIG. 18 shows different benchmark metrics in view 600. The metrics may be based on different search criteria 605 and filtered by category 610. For example, the search criteria 605 may include a search by owner or sort by other criteria. The filtered category 610 may include payroll, talent, time, benefits, state and budget metrics, as well other types of information as required by the user. The metrics, e.g., absence, acceptance to high rate, actual earnings as a percent of budget, actual labor costs as a percent of budget, actual costs as a percent of budget and actual sales versus plan, amongst other features, may be viewed by the user, which shows different comparisons to a benchmark. This view and underlying functionality, as it each of the different views and underlying functionality, can be used by the user for comparison purposes to determine proper worker compensation, etc., as described herein.

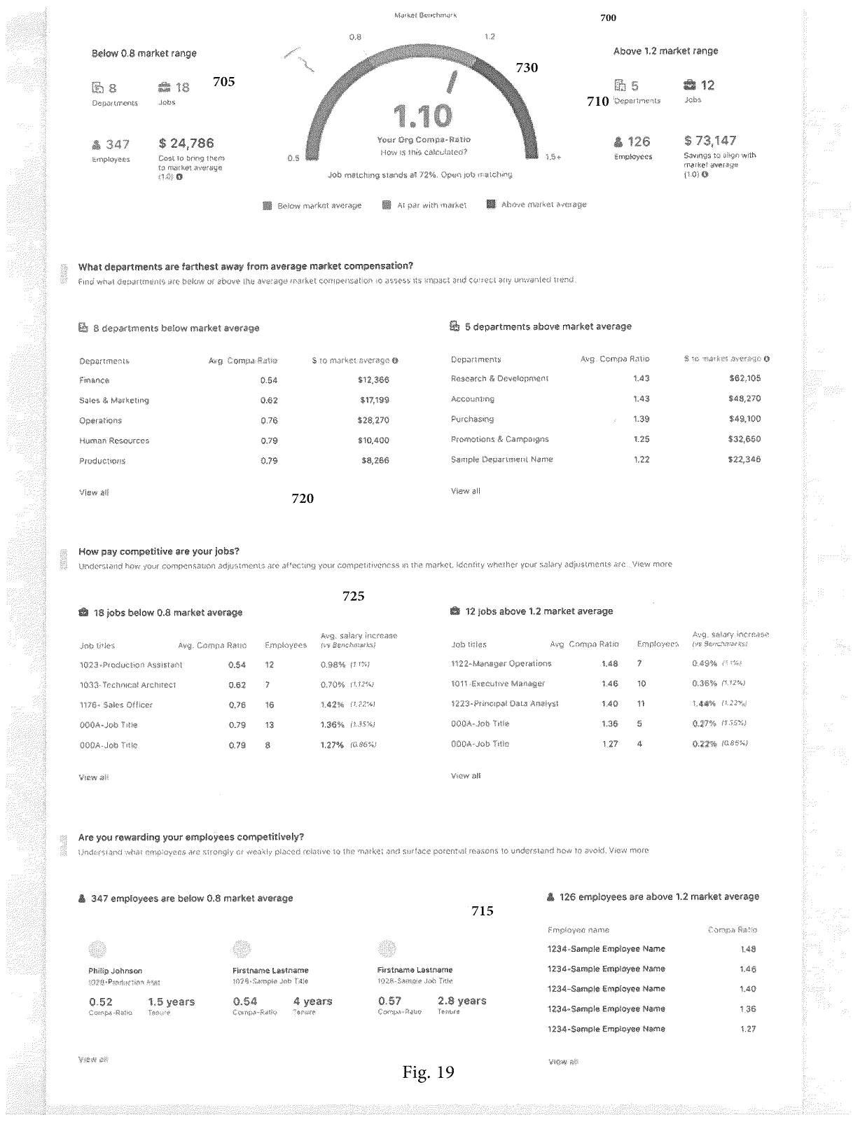

FIG. 19 shows a user interface 700 which provides a summary of different criteria based on an indication of below market range 705 and above market range 710 in a snapshot configuration using a comparison ratio. In this particular scenario, the user interface may include a graphical representation of an organization's comparison ratio at reference numeral 730, i.e., the comparison ratio is 1.10, with a job matching standing at 72%. In the below market range 705 and above market range 710, the comparison ratio can be provided for each of the different departments and people as shown using different criteria such as by employees 715, department 720 and jobs 725, amongst other criteria.

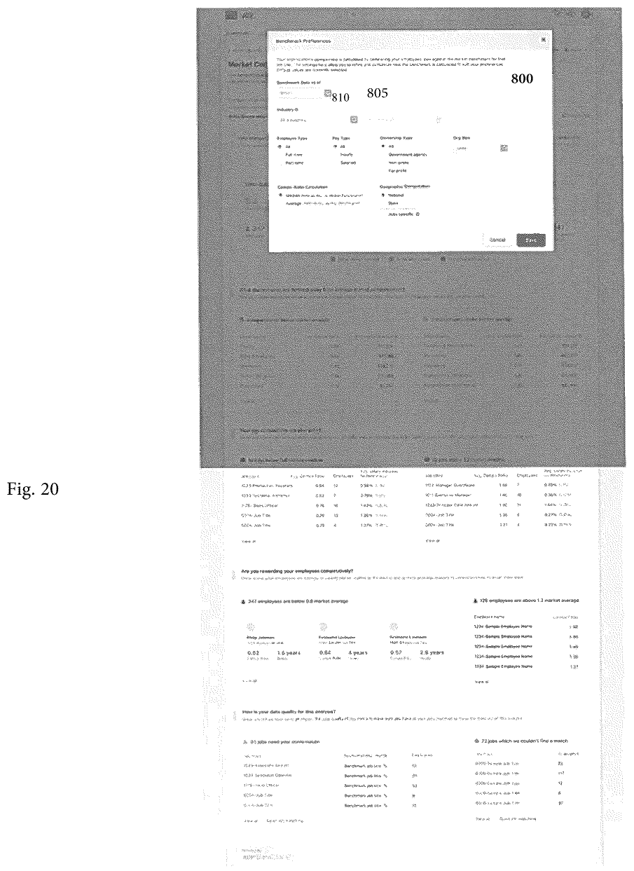

FIG. 20 shows a user interface 800 of benchmark preferences. The benchmark preferences 800 may be based on date 805, industry type 810, in addition to employee type, pay type, ownership type in organizational size, etc. A graphical computation may be selected based on a national, state, or job specific criteria. The geographical computation may also be based on. Other micro geographic locations, including municipality or particular regions. The interface 800 further includes a comparison ratio calculation based on a median or average; although as described herein, this compensation ratio calculation may also be based on different percentiles.

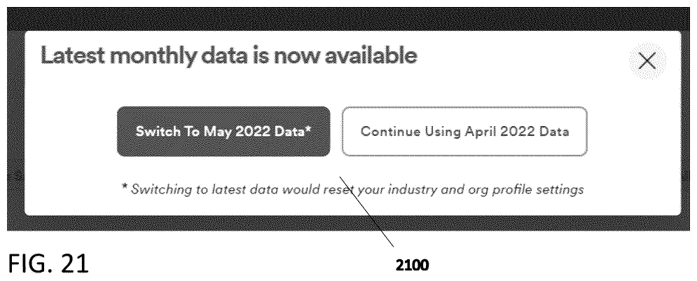

FIG. 21 shows an alert 2100 which notifies the user that a latest benchmark is available. As shown, the alert 2100 may allow the user to switch to the latest benchmark, e.g., based on a month time period (although other time periods are contemplated herein).

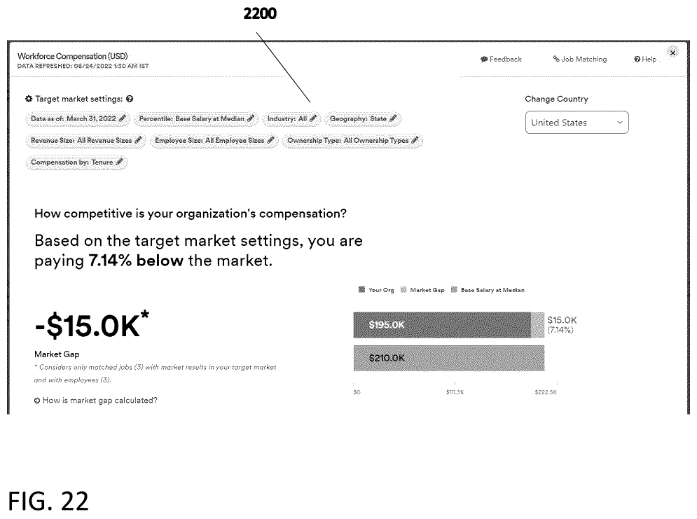

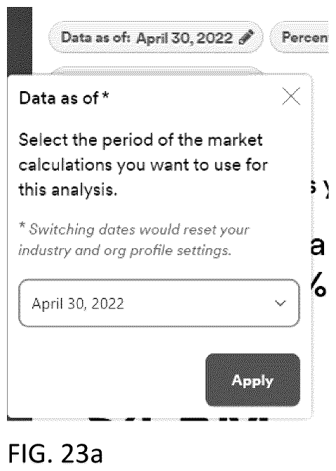

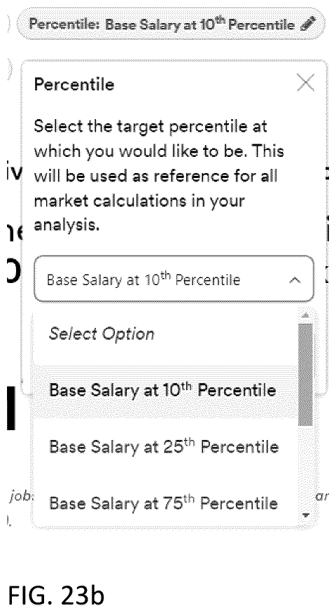

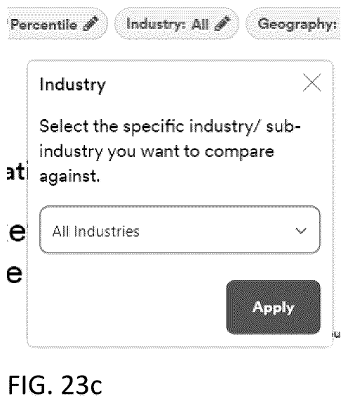

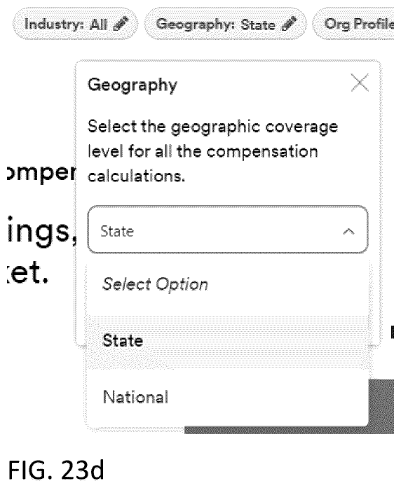

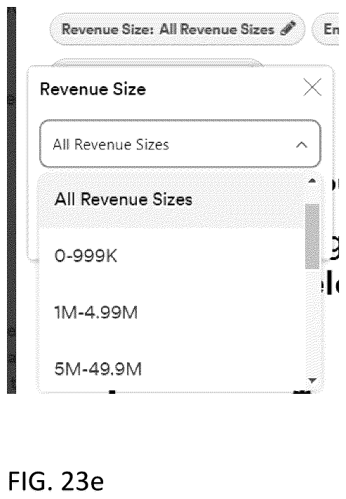

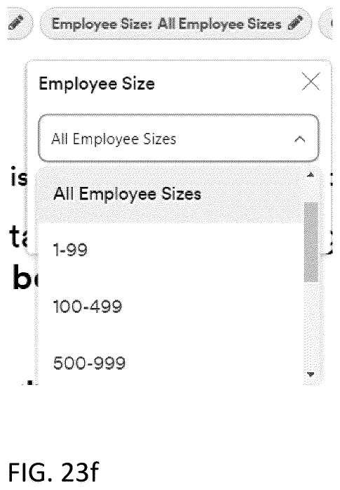

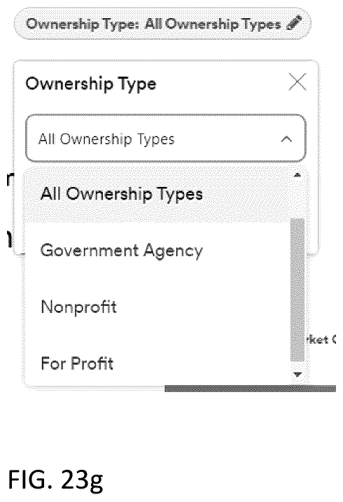

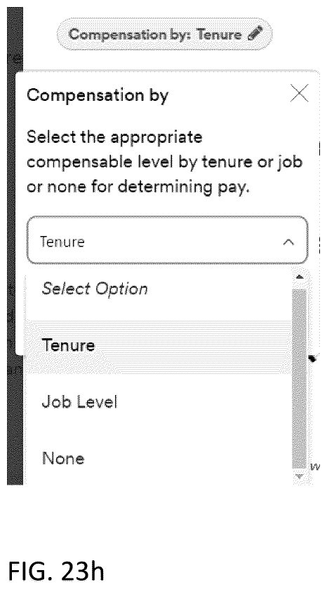

In FIG. 22, the compensation comparison may be provided using selected target market settings 2200. These target market settings 2200 may include any combination of, e.g., dates, percentiles, industry, geography, revenue size, employee size, ownership type, and compensation based on, for example tenure. The user interface will indicate the competitiveness of the organization's compensation based on the selected target settings, i.e., 7.1% below the market. The target market settings 2200 can be adjusted using drop down menus shown in FIGS. 23a-23i, in order to provide different comparisons of compensation based on the selected target market settings as described herein.

For example, FIG. 23a shows a dropdown menu for selecting particular dates for the market compensation comparisons. FIG. 23b shows a dropdown menu to select a target percentile for the for the market compensation comparisons. The target percentile can be selected based on the 10th percentile for example; however, the percentiles may be any desired percentiles, e.g., the 10th percentile, 25th percentile, 75th percentile etc. FIG. 23c shows a dropdown menu in which the user can select a specific industry for the for the market compensation comparisons. FIG. 23d shows a dropdown menu which allows the user to select a specific geographic location for the market compensation comparisons. This can be for example, state, national or another geographic region. FIG. 23e shows a dropdown menu in which the user can select revenue size for an organization for the market compensation comparisons. FIG. 23f shows a dropdown menu in which the user can select a size of the organization for the market compensation comparisons. FIG. 23g shows a dropdown menu in which the user can select an ownership type for the market compensation comparisons. The ownership type maybe all ownership types, government agencies, non-profit, for profit etc.

FIG. 23h shows a dropdown menu in which the user can select different compensation based on tenure, job level, etc. for the market compensation comparisons. This drop down menu allows the user to select a value. FIG. 23i shows a dropdown menu in which the user can select a particular country for the market compensation comparisons. In this case the United States and Canada are shown; however, other countries are also applicable.

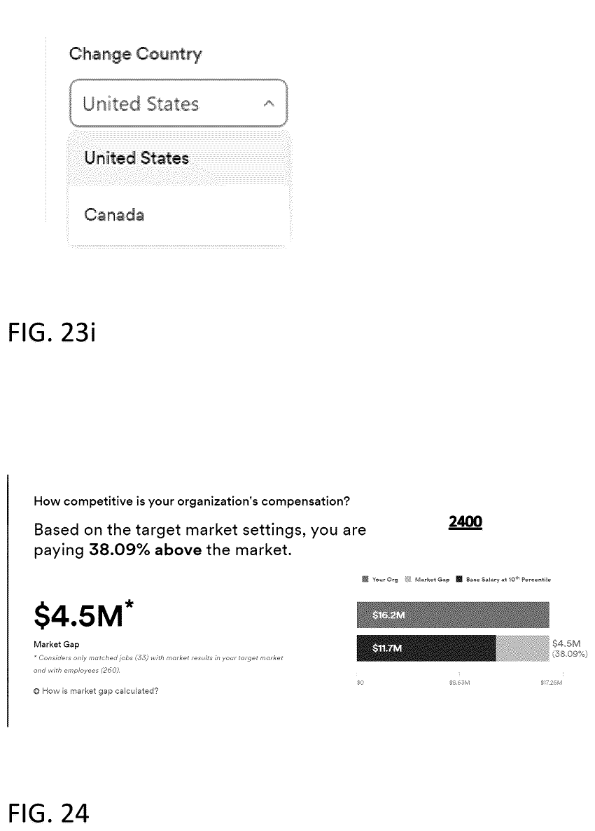

FIG. 24 shows a user interface 2400 which indicates how competitive an organization's compensation is based on the selected market settings. In this illustration, for example, the organization is paying 38.09% above the market rate, with a market gap of $4.5 million.

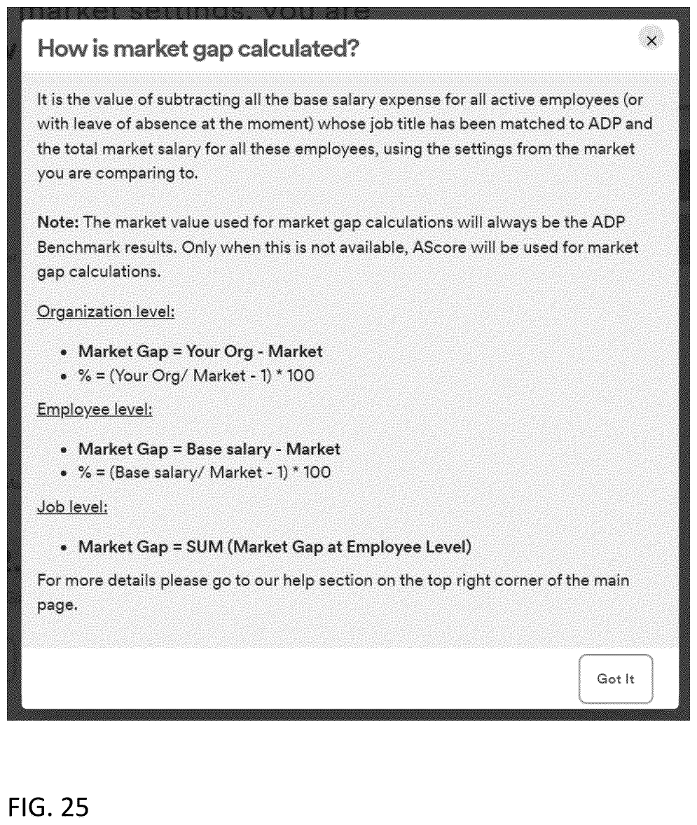

FIG. 25 shows an example of how a market gap is calculated. The market gap is the value of subtracting all the base salary expenses for all active employees or those on leave of absence whose job title has been matched to ADP (or other service provider) to the total market salary for all these employees using the settings from the market in which there is the comparison. The market value used for the market gap calculations may be based on benchmark results. The Ascore may also be used for market gap calculations.

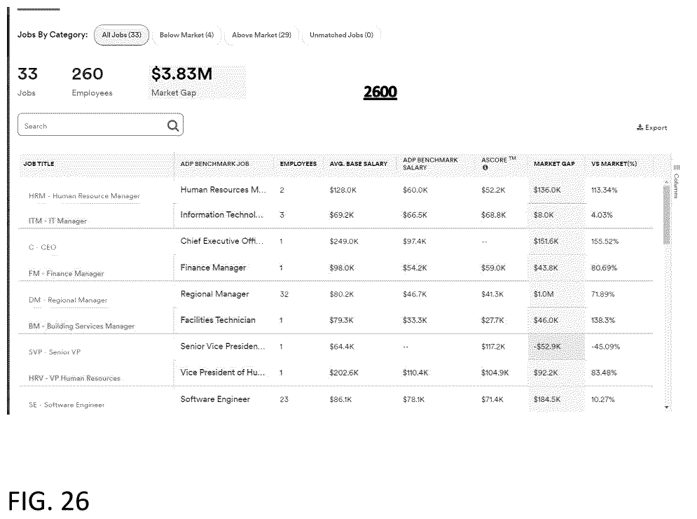

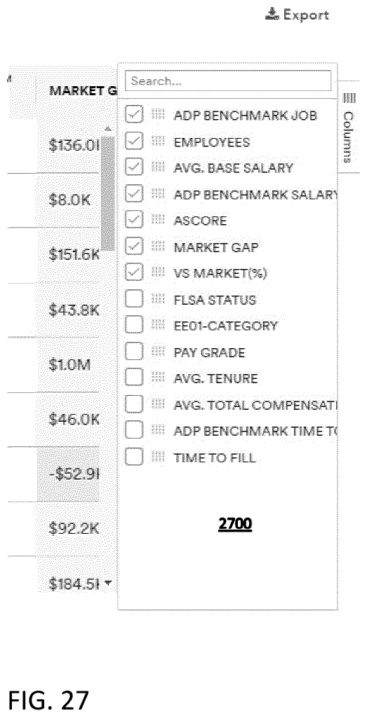

FIG. 26 shows a user interface 2600 based on categories of all jobs, below market, above market and unmatched jobs. In this scenario, the interface 2600 shows, e.g., the number of employees, average base salary, a benchmark salary, the Ascore, market gap and vs market %. FIG. 27 shows different filters (via drop down menu 2700) which can be used to modify the columns shown in FIG. 26.

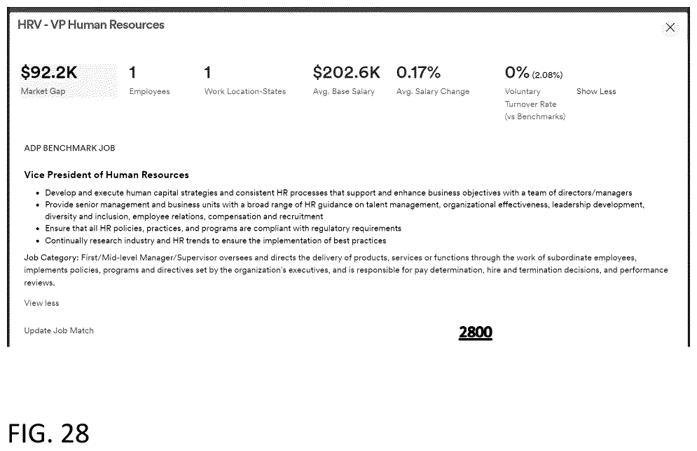

FIG. 28 shows a human resource interactive screen 2800. The human resource interactive screen 2800 shows a benchmark job description. This benchmark job description may be used in order to ensure that the jobs for the compensation comparison are compatible with one another, e.g., that different jobs with the same or similar title are not being compared to one another. That is, the human resource screen 2800 allows the user to determine that the comparisons are accurate between similar job responsibilities.

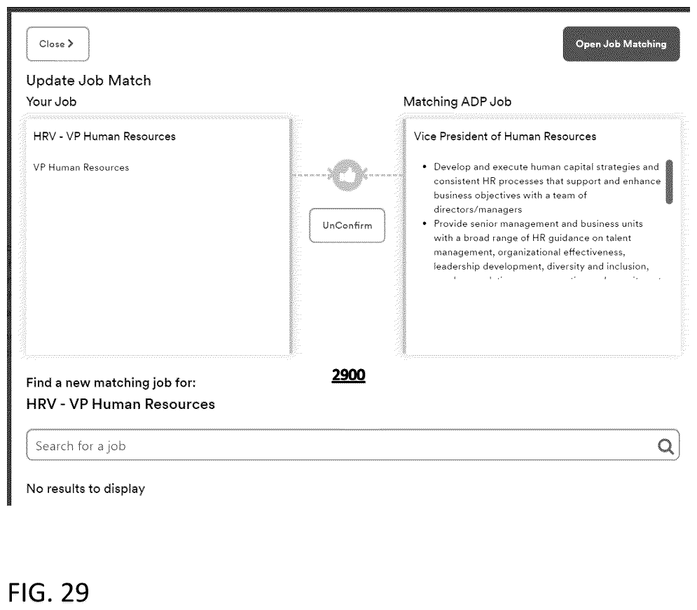

FIG. 29 shows a “job matching screen” 2900. In interface 2900, it is possible for the user to update the job title and job description and match them together. This allows the user to confirm or unconfirmed that a job title matches a job role, and further allows the user to, for example, change the job description to better fit a job tile for future compensation comparisons.

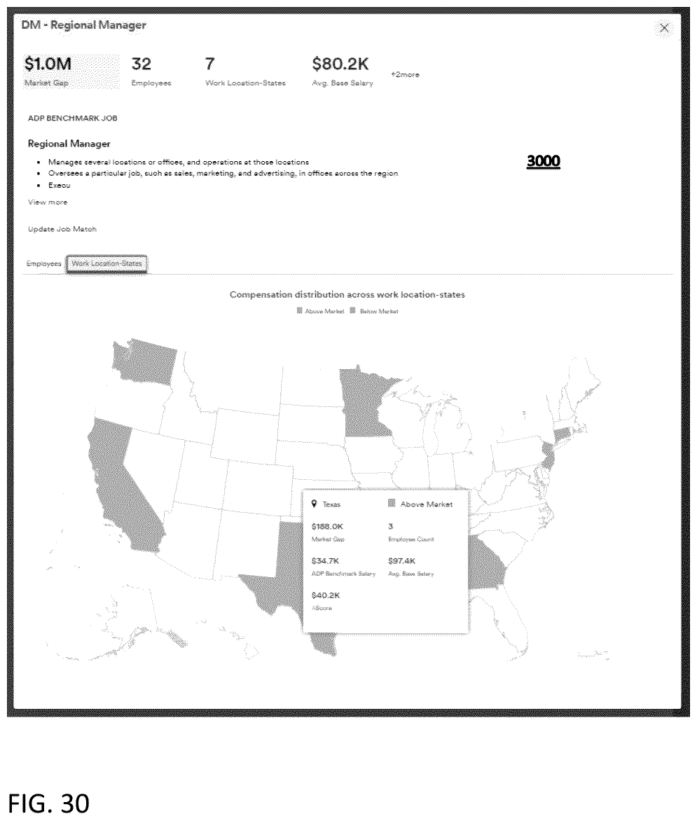

FIG. 30 shows an interactive screen 3000 for compensation distribution across work locations-states; although other geographical areas are also contemplated herein. The interactive screen 3000 shows the compensation distribution for a particular job type, e.g., regional manager. By selecting a particular location, e.g., state, the interface 3000 can show the particular statistics of the state, number of employees, benchmark salary and Ascore, amongst other examples. In this way, the interface 3000 allows a user to determine or compare benchmarks of a particular job title to different regions within the United States or other locale.

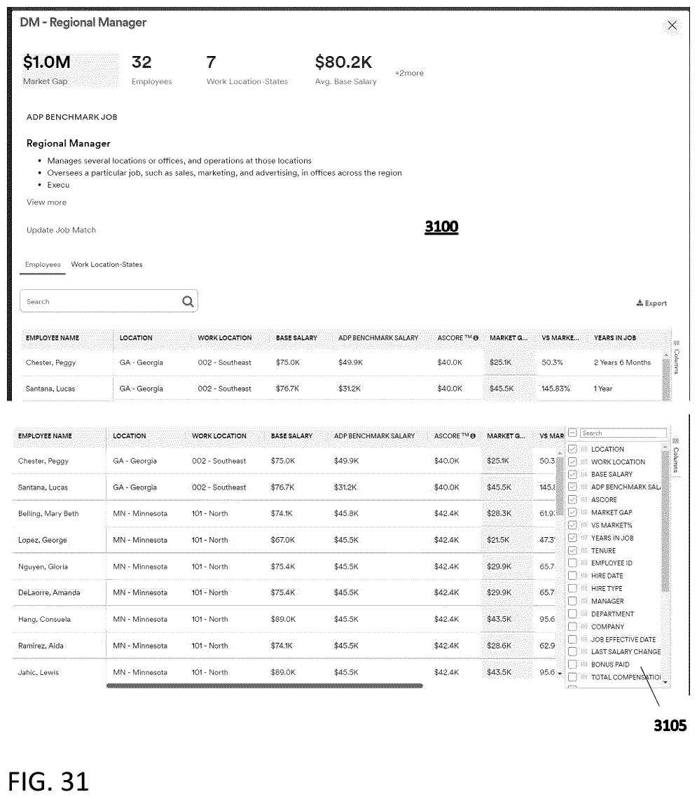

FIG. 31 shows an interactive screen 3100 based on a particular job type, e.g., regional manager. In this example, the interactive screen 3100 provides a description of the job, in addition to information about, e.g., employee name, location, work location, base salary, benchmark salary, Ascore, market gap, etc., as selected by the user in the drop down menu 3105. In this way, the interactive screen 3100 allows the user to select or filter different criteria, which then can be shown for comparison purposes.

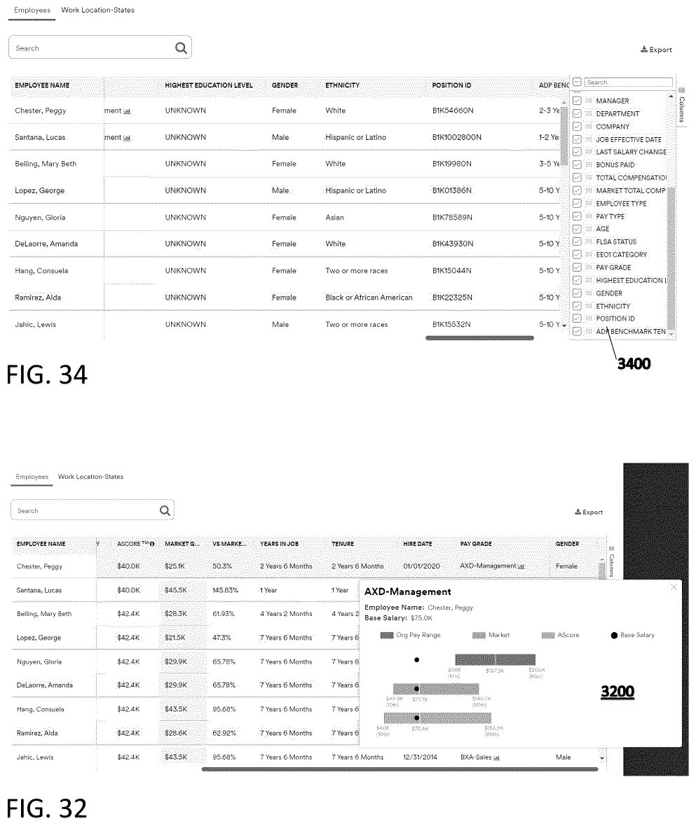

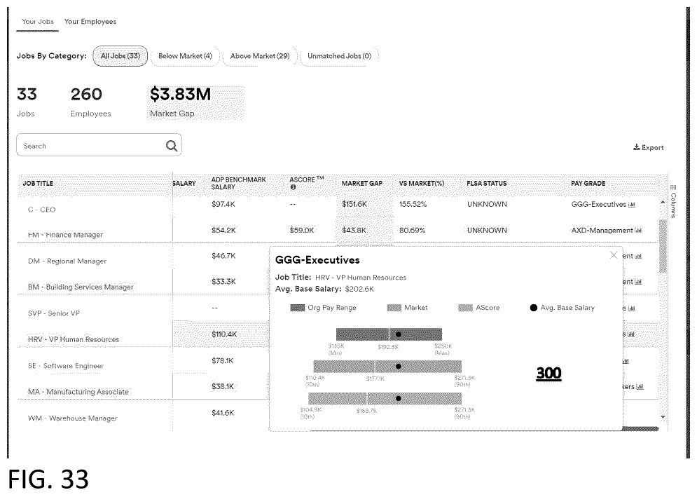

FIG. 32 shows a graphical representation 3200 comparing a particular selected employee to others in a similar job. This may include organization's pay range, the market pay range, the Ascore, and average base salary, amongst other selected items. Similarly, FIG. 33 shows a graphical interface 3300 for a particular job title. This can be based on other criteria such as years on the job, tenure, hire date, pay grade, etc. as shown in drop down menu 3400 of FIG. 34.

The tools provided herein may provide the user, organization or other party, e.g., manager, human resources, with notifications that an employee is above or below a benchmark or within a certain percentile of compensation for a particular job type in a particular region, amongst other comparisons. The notification may be an email, text message or other type of notification known to those of ordinary skill in the art such that no further explanation is required for a complete understanding of the present invention. These notifications may be pushed or pulled notifications. Also, these notifications may include recommendations of remedial actions or recommendations such as providing different compensation schemes to the employees. This compensation may include, e.g., cash salary, bonuses, additional paid leave etc., based on the benchmarks and/or industry standards, for example. This will allow the organization to be proactive with respect to the worker compensation to ensure worker retention, etc.

Accordingly, in view of the above, it should now be understood that the user interfaces described with respect to FIGS. 3-34 and their underlying functionality may provide compensation analysis, including an overview or assessment of an organization's standing in compensation compared to other organizations either based on benchmarks, to comparison rations or market settings. The market settings can always be refined in the target market settings of the tool as described above and, in more detail, below.

### Examplary User Scenario

The user interfaces described with respect to FIGS. 3-34 and their underlying functionality show an overall overview of how competitive an organization is against the market while allowing the user to drill down into more details, i.e., based on jobs and employees. The job snapshot is accessible by clicking on any specific job title and provides more details about the employees in that job for further analysis. The tool will summarize the compensation situation by job or other criteria, and provide market gaps based on every employee's compensation in each job and a benchmark compensation for the market as defined by the user. These details include, for example, compensation insights, details about average tenure or turnover rate (amongst others) to help further assess these job's compensation competitiveness. As noted already, job matching as described in FIGS. 28 and 29, ensures accurate analysis. For example, if the jobs are not matched, the tool will not have a benchmark value for those jobs and all the employees with such title will not be accounted in the analysis.

Market gap represents the difference on compensation between an organization and a target market which is comparing to. The market gap can be calculated at different levels, e.g., organization level, job level or employee level.

### Organization Level:

An absolute value of subtracting an organization base salary expense for all active employees (or with leave of absence at the moment) whose job title has been matched to the benchmark of the service provider (ADP) and the total market salary for all these employees, using the target market settings.

For example, a calculation for a company with 3 employees and 2 job titles with 50th target percentile would be as follow:

| Employee | Job Title | Base Salary | Market base salary (50th) |
|---|---|---|---|
| Arindam | Partnership Manager | $75k | $70k |
| Sriranjani | Senior Accountant | $110k | $115k |
| Curro | Senior Accountant | $104k | $115k |

Your org=$75 k+$110 k+$104 k=$289 k

Market (50th percentile)=$70 k+$115 k+$115 k=$300 k

Market Gap=ABS(Your Org−Market)=ABS($289 k−$300 k)=ABS(−$11 k)=$11 k

%=(Your Org/Market−1)*100=($289 k/$300 k−1)*100=−3.7%

### Job Level:

Base salary=SUM(base salary of all employees with specific job title)

Market=SUM(market base salary of all employees with specific job title)

Market Gap=ABS(Base salary−Market)

%=(Base salary/Market−1)*100

Partnership Analyst

Market Gap=ABS($75 k−$70 k)=ABS($5 k)=$5 k

%=($75 k/$70 k−1)*100=+7.1%

Senior Accountant

Market Gap=ABS($110 k+$104 k−$115 k−$115 k)=ABS(−$16 k)=$16 k

%=(($110 k+$104 k)/($115 k+$115 k)−1)*100=−6.9%

### Employee Level:

Arindam

Market Gap=ABS($75 k−$70 k)=ABS($5 k)=$5 k

%=($75 k/$70 k−1)*100=+7.1%

Sriranjani

Market Gap=ABS($110 k−$115 k)=ABS(−$5 k)=$5 k

%=($110 k/$115 k−1)*100=−4.3%

Curro

Market Gap=ABS($104 k−$115 k)=ABS(−$11 k)=$11 k

%=($104 k/$115 k−1)*100=−9.5%

As further noted, the interfaces described herein summarizes the compensation situation in an organization by employee or job title, etc. Market gaps are determined based on every employee's compensation and the benchmark compensation for the market as user defined settings. Multiple compensation parameters can be found based on demographics, individual and organizational details to help further assess employees' compensation competitiveness. Calculations may be performed using active employees (or with leave of absence at the moment) whose job title has been matched to a service provider (e.g., ADP). The tool identifies and highlights those employees with jobs that have not been matched, though no market comparison is provided for these, thereby may not be accounted for the market gap calculations.

The geography level computation defines the level at which the benchmarks are being calculated. The national level is calculated using data from the whole country while the state level uses data from each particular state only. Other levels of granularity are also contemplated herein. This can therefore lead to significant differences in the benchmark calculations depending on what state your employees are. To illustrate the differences from National vs State, the following example is provided in the following table.

| Geography | Job title | California | New York | Florida | Texas |
|---|---|---|---|---|---|
| National | Senior | $100.000 | $100.000 | $100.000 | $100.000 |
| | Accountant | | | | |
| State | Senior | $110.000 | $105.000 | $90.000 | $95.000 |
| | Accountant | | | | |

As further described herein, it is possible to use target market settings, e.g., preferences (filters) when analyzing data. These preferences can be used to benchmark an organization against a more refined or limited benchmark dataset. The benchmarks are preferably as broad as possible, while still staying relevant to benchmark needs. The more specific the benchmark selection, the less benchmark data available. These benchmarks may include:

Data as of (FIG. 23a):

This provides the user with the ability to select benchmarks against a particular month or other date range. Whenever latest benchmarks are generated, a popup may be provided to the user to switch to the latest month or other time period, as an example. If the user changes to another period, then the selection of the industry and organization profile settings selection is lost.

Percentile (FIG. 23b):

This allows the user to identify outliers quickly based on selection of base salary at 10^{th} and 90^{th} percentile. Users would be able to select different percentiles (10^{th}, 25^{th}, average, 50^{th}, 75^{th}, 90^{th}) to compare against the market based on their compensation strategy.

Industry (FIG. 23c):

This allows the user to select the market pay based on the industry that they belong to. This may be based on the standard NAICS (North American Industry Classification System) industry hierarchy. The more generic the industry, the greater the number of organizations in the dataset and likelihood of rendering data. Of course, using a “Single Industry” to view benchmarks would get the user as close to their organization as possible. The industry hierarchy may start at the “Single Industry” level, which is the most granular level. This maps to NAICS6 in the NAICS. There can be, for example, 7 supersectors, 27 sectors, and 147 subsectors, and ˜1K single industries.

Geography (FIG. 23d):

This allows the user to select either state or national or other geographical level for determination of the benchmarks as per their compensation strategy.

Revenue Size (FIG. 23e):

This allows the user to select different revenue bands to see how users of similar revenue size are paying differently in the market.

Employee Size (FIG. 23f):

This allows the user to select different employee ranges to see how users of similar employee size are paying differently in the market.

Ownership Type (FIG. 23g):

This allows the user to select Government Agency, Non-Profit, For Profit to see how clients of similar ownership type are paying differently in the market.

Compensation by (FIG. 23h):

This allows the user to select Job Level/Tenure Band to determine market gap as close to the employee level/experience within the organization. The user can select ‘None’ if they would want to compare against generic market pay.

If benchmarks are not available for a respective job level, the benchmark/AScore data for the job (without levels) are considered for determining market gap. The AScore may be an estimate of compensation across many dimensions such as job title, location, and industry. The AScore factors in multiple data points from clients and government agencies such as the Bureau of Labor Statistics (for US only). It also incorporates geographic and economic development indicators and job market dynamics (that is, supply and demand). In searches where both the AScore and benchmarks, the AScore can be used as supplemental information. The AScore may provide an adjusted compensation estimate that mitigates for potential biases that may exist in client data, such as having too many small-sized clients in a specific search.

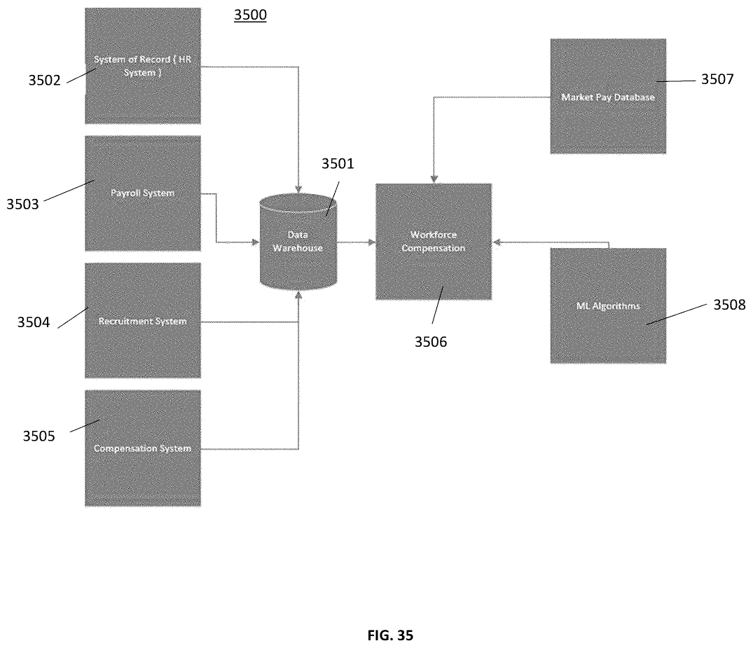

FIG. 35 depicts a block diagram of components and respective functionality in accordance with aspects of the present disclosure. More specifically, FIG. 35 shows a functional block diagram 3500 that illustrates functionality of aspects of the present disclosure. In embodiments, the tool (e.g., server and/or device) comprises a data warehouse module 3501 which obtains information from a system of record (human resources system) 3502, a payroll system 3503, a recruitment system 3504 and a compensation system 3505, each of which may comprise one or more program modules such as program modules 165 described with respect to FIG. 1. The functional block diagram 3500 further comprises a workforce compensation module 3506, which obtains necessary information from the data warehouse module 3501, in addition to a market pay database 3507. In embodiments, the market pay database 3507 may include compensation and other statistics or data associated with the marketplace as already described. Using machine learning algorithms 3508, the workforce compensation module 3506 may provide the functionality as described herein. For example, the workforce compensation module 3506 may make comparisons of compensation within a particular industry, within a particular geographic location and for a particular job title or description using the filters and information described herein.

The tools (e.g., server/device) may include additional or fewer modules than those shown in FIG. 35. In embodiments, separate modules may be integrated into a single module. Additionally, or alternatively, a single module may be implemented as multiple modules. Moreover, the quantity of devices and/or networks in the environment is not limited to what is shown in FIG. 35. In practice, the environment may include additional devices and/or networks; fewer devices and/or networks; different devices and/or networks; or differently arranged devices and/or networks than illustrated in FIG. 35.

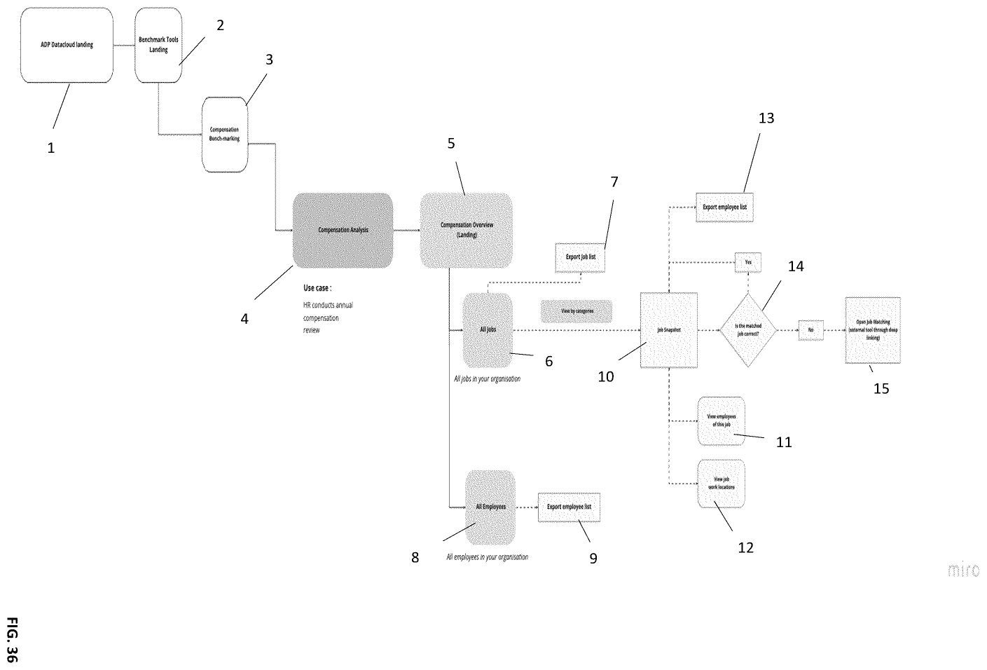

FIG. 36 depicts an exemplary flow for a process in accordance with aspects of the present disclosure. The exemplary flow can be illustrative of a system, a method, and/or a computer program product and related functionality implemented on the computing system of FIG. 1, in accordance with aspects of the present disclosure. The computer program product may include computer readable program instructions stored on computer readable storage medium (or media). The computer readable storage medium may include the one or more storage medium as described with regard to FIG. 1, e.g., non-transitory media, a tangible device, etc. The method, and/or computer program product implementing the flow of FIG. 36 can be downloaded to respective computing/processing devices, e.g., computing system of FIG. 1 as already described herein, or implemented on a cloud infrastructure as described with regard to FIG. 2. Accordingly, the processes associated with each flow of the present disclosure can be implemented by special purpose hardware-based systems that perform the specified functions or acts or carry out combinations of special purpose hardware and computer instructions.

More specifically, at step 1, the process flows to a data cloud landing page, at which stage a user may enter the system. At step 2, the process flows to a benchmark tools landing, at which stage benchmark data may be obtained. At step 3, the process flows to a compensation benchmarking, at which stage benchmark compensation may be obtained and/or entered. At step 4, a compensation analysis is performed. At step 5, a compensation overview is generated and, in embodiments, provided to a user. At step 6, all jobs or subset of jobs can be analyzed within an organization. This may include, for example, exporting a job list at step 7. At step 8, all employees or subset of employees can be analyzed within an organization. This may include, for example, exporting an employee list at step 9.

At step 10, a job snapshot can be generated and presented. At step 11, the process can generate a view of employees for the specific job and at step 12, the process can generate a view of job work locations. At step 13, the process can export the employee list. At step 14, the processes will determine whether the matched job is correct. If yes, the process will revert back to step 10, at which time a new description of the job or job title may be used to again generate the comparison features. If not, the process can continue to step 15 at which time an open hob matching may be provided through an external link.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method of comparing compensation, comprising:
obtaining, by a computer system, a compensation benchmark for a particular job;
obtaining, by the computer system, information of employees for the particular job title; and
generating, by the computer system, a comparison of compensation of the employees for the particular job title and the compensation benchmark.

2. A computer program product comprising one or more computer readable storage media having program instructions collectively stored on the one or more computer readable storage media, the program instructions executable to:
obtain selected target market settings; and
obtain benchmark compensation associated with the selected target market settings;
determine competitiveness of an organization's compensation based on the selected target settings and the benchmark compensation; and
provide a report with recommendations to ensure the competitiveness of the organization's compensation.

3. A system comprising a processor, a computer readable memory, one or more computer readable storage media, and program instructions collectively stored on the one or more computer readable storage media, the program instructions executable to determine market compensation of an employee by comparing current compensation of an employee based on market settings associated with a predetermined job title or job description with a benchmark compensation for the predetermined job title or job description.
